(19) United States
(12) Patent Application Publication
(10) Pub. No.: US 2017/0283259 A1
(43) Pub. Date: Oct. 5, 2017

(54) Nano-Structured Catalysts

(71) Applicants: Fei Yu, Starkville, MS (US); Qiangu Yan, Starkville, MS (US)

(72) Inventors: Fei Yu, Starkville, MS (US); Qiangu Yan, Starkville, MS (US)

(21) Appl. No.: 15/476,546

(22) Filed: Mar. 31, 2017

Related U.S. Application Data
(60) Provisional application No. 62/316,075, filed on Mar. 31, 2016.

(51) Int. Cl. C01B 3/40; B01J 37/08; B01J 37/02; B01J 35/10; B01J 23/30; B01J 37/06; B01J 35/02; B01J 35/00; B01J 23/755; B01J 23/28

(52) U.S. Cl. CPC C01B 3/40; B01J 23/755; B01J 37/08; B01J 37/0213; B01J 37/0236; B01J 23/28; B01J 23/30; B01J 37/06; B01J 35/023; B01J 35/0013; B01J 35/1019; C01B 2203/1058; C01B 2203/1082; C01B 2203/0238

(57) ABSTRACT

The present invention provides novel systems, methods, and processes for producing and synthesizing, through cost-effective thermal processes, highly active and stable carbide-based nano-structured catalysts and compositions that can be used in dry reforming of methane, natural gas, and biogas, for example, to synthesis gas (syngas). The invention provides for using carbon-containing raw materials for synthesizing and producing carbon-encapsulated metal-core nanoparticles such as nickel-based, tungsten-based, and molybdenum-based nano-structured catalysts that can be used in dry reforming gas to syngas.

### CROSS-REFERENCE TO RELATED APPLICATION

This application claims priority from U.S. Provisional Patent Application Ser. No. 62/316,075 filed Mar. 31, 2016. The entirety of the provisional application is incorporated herein by reference.

### STATEMENT OF GOVERNMENT SUPPORT

This invention was made with government support under Award Nos. 2012-10008-20302 and 1002403 awarded by the National Institute of Food and Agriculture, U. S. Department of Agriculture. The government has certain rights in the invention.

### FIELD OF THE INVENTION

The present invention relates to carbide-based nano-structured catalysts, methods for synthesizing, and methods of use. In particular, nickel, tungsten and molybdenum-based catalysts, methods of synthesis, and methods of using the catalysts for methane dry reforming are disclosed.

### BACKGROUND OF THE INVENTION

Biogas from landfill sources is usually composed of 45-55% CH₄, 30-40% CO₂, and 5-15% N₂, while biogas from organic waste anaerobic digesters usually contains from 55-65% CH₄, 35-45% CO₂, and 1% N₂. The primary use of biogas is as internal combustion engine (ICE) fuel, but the high CO₂ concentration decreases its energy value and limits engine peak power. Furthermore, unstable engine performance and high CH₄ concentrations in the exhaust will arise when the engine loads are low. Efforts have been performed to remove CO₂ from biogas before it is used as ICE fuel; however, this practice may increase the process cost and decrease its availability in power generation and transportation. Biogas can be used as an alternative of natural gas for electricity production. As a renewable resource, biogas has also been studied for production of hydrogen as fuel cell feedstock; however, a high level of purity is required which makes the process unprofitable. Another promising approach is biogas reforming to syngas, followed by generating liquid hydrocarbons through Fischer-Tropsch synthesis (FTS). Currently, in industry, syngas is mainly made from natural gas or coal, neither of which are renewable/sustainable feedstock.

Methane (CH₄) and carbon dioxide (CO₂) are main components of biogas. Both have been identified as significant greenhouse gases and they are also key reactants for the dry reforming process. This makes the dry reforming process of great importance to reduce greenhouse gas emissions by dry reforming biogas to syngas.

Nickel-based catalysts are commercially used for CH₄ reforming due to their low costs compared to noble metals. However, these nickel catalysts are likely to be deactivated by coke formation during methane decomposition and CO disproportionation. Efforts have been dedicated to searching for new catalysts that are resistant to carbon formation. Nickel nanoparticles are usually highly activated and tend to be deactivated by carbon deposition. Carbon encapsulation of metal nanoparticles could retain their intrinsic nanocrystalline properties and keep them from deactivation by coking. The carbon coatings can endow these nanoparticles with stability in methane reforming processes.

Transition metal carbides have been studied as catalytic materials, have demonstrated exceptionally high activity, and are more robust in a reaction environment containing impurities like sulfur and chlorine. It has been reported that transition-metal carbides, especially tungsten and molybdenum carbide, have excellent noble metal-like catalytic activity, stability, and selectivity for a wide range of reactions. These metal carbides have been reported as catalysts for the dry reforming of methane and have shown considerable resistance to carbon deposition.

Tungsten carbides are usually synthesized by a traditional direct carburization method, which is based on a direct solid reaction between tungsten and carbon elements, reduction of the tungsten oxide (WO₃) by carbon, thermo-chemical spray drying process, mechanical alloying (MA), and chemical vapor condensation (CVC). Carbothermal hydrogen reduction is also frequently used for tungsten carbide preparation. A number of methods have been developed to prepare nanostructure metal carbides, such as the thermo-chemical spray drying process, mechanical alloying, pyrolysis of metal complexes, alkaline reduction in solution, temperature-programmed reduction, carbothermal hydrogen reduction, and sonochemical synthesis.

Many types of starting materials have been studied as carbon sources for the fabrication of metal carbides, i.e. light hydrocarbons like methane, propane and CO, carbon black, and organometallic precursors. To lower the cost of raw carbon materials, widely-available biomass that is rich in carbon can be a substitute for pure saccharides. Carbon-encapsulated iron nanoparticles have also been successfully synthesized using wood-derived sugars as the catalyst support pre-cursor.

Biochar, a significant byproduct from fast pyrolysis of lignocellulosic biomass for bio-oil production, is also rich in carbon (>60 wt %) and traditionally used as a soil amendment. Similar to activated carbon, the surface chemistry of biochar can be modified via chemical methods with different oxidants to obtain functional groups crucial for catalyst fabrication. Therefore, biochar is an abundant and low-cost renewable carbon source and has the potential for value-added carbonaceous nanoparticle synthesis.

To date, however, for many applications there remains a need for methods to reduce the cost of raw carbon materials used in the synthesis of catalysts. Moreover, there exists a need for catalysts that are stable in methane reforming processes and are not deactivated by coke formation. A simple, scalable process and method that can utilize less expensive materials in a shorter time frame would also aid in commercialization efforts for nanocage applications. The present invention provides such methods and catalysts.

### SUMMARY OF THE INVENTION

The present invention provides a new system, methods, and processes for producing and synthesizing highly active and stable nano-structured catalysts and compositions that can be used in dry reforming of methane, natural gas, and biogas, for example, to synthesis gas (syngas). Further provided are techniques for maintaining catalyst stability.

With the foregoing and other objects, features, and advantages of the present invention that will become apparent hereinafter, the nature of the invention may be more clearly understood by reference to the following detailed description of the preferred embodiments of the invention and to the appended claims.

### BRIEF DESCRIPTION OF THE DRAWINGS

These drawings accompany the detailed description of the invention and are intended to illustrate further the invention and its advantages. The drawings, which are incorporated in and form a portion of the specification, illustrate certain preferred embodiments of the invention and, together with the entire specification, are meant to explain preferred embodiments of the present invention to those skilled in the art.

FIG. 1 is a graph of the lifetime test of methane dry reforming over the Example 1A nanoparticle at 850° C., GHSV of 6000 h⁻¹ and a constant feed (CH₄/CO₂) ratio of 1 for a time on stream of 0 to 500 hours. Data for CH₄ conversion, CO₂ conversion, and CO yield are included.

FIG. 2 is a graph of the lifetime test of methane dry reforming of natural gas over the Example 1A nanoparticle at 850° C., GHSV of 6000 h⁻¹ and a constant feed (CH₄/CO₂) ratio of 1, for a time on stream of 0 to 100 hours. Data for CH₄ conversion, CO₂ conversion, and CO yield are included.

FIG. 3 is a graph of the lifetime test of methane dry reforming over the Example 1B nanoparticle at 850° C., GHSV of 6000 h⁻¹ and a constant feed (CH₄/CO₂) ratio of 1. Data for CH₄ conversion, CO₂ conversion, and CO yield are included.

FIG. 4 is a graph of the lifetime test of methane dry reforming over the Example 1C nanoparticle at 850° C., GHSV of 6000 h⁻¹ and a constant feed (CH₄/CO₂) ratio of 1. Data for CH₄ conversion, CO₂ conversion, and CO yield are included.

FIG. 5 is a graph of the lifetime test of methane dry reforming over the Comparative Example nanoparticle at 850° C., GHSV of 6000 h⁻¹ and a constant feed (CH₄/CO₂) ratio of 1. Data for CH₄ conversion, CO₂ conversion, and CO yield are included.

FIG. 6 is a graph showing XRD patterns of: the calcined nickel pre-impregnation char at 300° C. under an argon flow (FIG. 6a), the thermal treated nickel-promoted char at 900° C. for 2 hours under an argon flow (FIG. 6b), and the thermal treated nickel-promoted char after being used in methane dry reforming at 850° C. for ten hours (FIG. 6c).

FIGS. 7a-7c are scanning electron microscope (SEM) images that show the morphology of nickel-promoted biochar samples: (a) NiO particles are distributed well on char surface for the calcined sample, with the average size of 30-50 nm size; (b) thermal treated nickel-promoted biochar surface (both the char matrix and the outer surface of the biochar) was filled with nanoparticles; the nanoparticles in the char matrix ranged between 5 nm and 10 nm in diameter, while the particles on the outer surface ranged between 30-80 nm; and (c) the nanoparticles after dry reforming for about 10 hours showed little change.

FIGS. 8a-8b are typical TEM images of nickel-promoted biochar after carbothermal reduction at 900° C. for 1 hour consisting of nickel nanoparticles, with particle sizes of approximately 30-50 nm.

FIGS. 8c-8d are TEM images further showing that thermal treated nickel-promoted biochar after dry reforming of methane at 850° C. for about 10 hours is also composed of nickel nanoparticles (FIG. 8c), but the particles have size ranges of 5-50 nm. Most nickel nanoparticles were wrapped by a graphene layer after thermal treatment and methane dry reforming (FIGS. 8b and 8d); the metallic core is encapsulated in polyhedral concentric graphene shells with a varying number of layers.

FIG. 9 is a graph showing the trends of purging gas species during temperature-programmed thermal treatment of the nickel doped char sample. Hydrogen, methane, water, carbon monoxide, and carbon dioxide evolution for the temperature-programmed thermal treatment of a bio-char doped with Ni, 10° C./min to 850° C., purging gas: 50 ml/min helium.

FIGS. 10a-10b are graphical illustrations showing results of temperature programmed methane dry reforming reaction (CH₄+CO₂→2CO+2H₂) over carbon-encapsulated nickel nanoparticles from biochar.

FIGS. 11a-11b are graphical illustrations showing results of temperature programmed methane dry reforming reaction (CH₄+CO₂→2CO+2H₂) over 10% Ni/γ-Al₂O₃.

FIG. 11c is a graphical illustration showing the concentration of H₂, CH₄, CO, and CO₂ versus temperature obtained over a molybdenum-char (Mo-Char) sample.

FIG. 12 is an illustration of XRD patterns of tungsten-promoted biochar samples prepared by carbothermal reduction at different temperatures for 1 hour: (a) fresh, (b) 700° C., (c) 800° C., (d) 850° C., (e) 900° C., and (f) 1000° C.

FIGS. 13a-13d are SEM images of tungsten-promoted biochar after carbothermal reduction at 1000° C. for 1 hour (a-c) under different magnifications and (d) carbothermal reduction at 1000° C. for 3 hours.

FIGS. 14a-14b are typical TEM images of tungsten-promoted biochar after carbothermal reduction at 1000° C. (a) for 1 hour; and (b) for 3 hours.

FIGS. 15a-15b are graphs of temperature programmed carbothermal reduction (TPCR) curves of H₂, CH₄, CO, and CO₂ evolution during thermal activation for the temperature-programmed thermal treatment of (a) biochar and (b) tungsten-promoted biochar heated to 1000° C. at a heating rate of 10° C. min-1 and with a N₂ purging gas rate of 50 mL min.

FIGS. 16a-16b are graphs showing Thermogravimetric (TG) and Derivative Thermogravimetry (DTG) curves of (a) biochar and (b) tungsten-promoted biochar heated at a rate of 10° C. min⁻¹ in a N₂ atmosphere.

FIGS. 17a-17b are graphs showing the effect of reaction temperature on feed conversion and CO yield during CH₄/CO₂ reforming over tungsten carbide nanoparticles in a biochar matrix at a CH₄/CO₂ ratio of 1, 0.5 MPa and gas hourly space velocity (GHSV) of 6000 h⁻¹: (a) feed conversion and (b) H₂/CO ratio. Reaction time: 0.5-12 hours.

FIGS. 18a-18b are graphs showing the effect of the CH₄/CO₂ ratio on catalytic performance of tungsten carbide nanoparticles in the biochar matrix at 850° C., 0.5 MPa and GHSV of 6000 h⁻¹: (a) feed conversion and (b) H₂/CO ratio. Reaction time: 5-24 hours.

FIGS. 19a-19b are graphs showing the effect of gas hourly space velocity (GHSV) on catalytic performance of tungsten carbide nanoparticles in biochar matrix at 850° C., 0.5 MPa with CH₄/CO₂ ratio of 1: (a) feed conversion and (b) H₂/CO ratio. Reaction time: 5-24 hours.

FIG. 20 is a graph showing the lifetime test of dry methane reforming over the tungsten carbide nanoparticle in biochar matrix at 850° C., 0.5 MPa, GHSV of 6000 h⁻¹ and a constant feed (CH₄/CO₂) ratio of 1.

FIG. 21 is a TEM image of used WC/biochar after 500 hours dry methane reforming at 850° C., 0.5 MPa, GHSV of 6000 h−1 and a constant feed (CH₄/CO₂) ratio of 1.

### DETAILED DESCRIPTION OF THE INVENTION

The details of one or more embodiments of the present invention are described. Modifications to embodiments described, and other embodiments, will be evident to those of ordinary skill in the art after a study of the information provided. The information and the specific details of the described exemplary embodiments are provided primarily for understanding and no unnecessary limitations are to be assumed therefrom. In case of conflict, the specification herein, including definitions, will control.

Unless defined otherwise, all technical and scientific terms used herein have the same meaning as is commonly understood by one of ordinary skill in the art to which the invention belongs. All patents, patent applications, published applications and publications, databases, websites and other published materials and references listed and referred to, unless noted otherwise, are incorporated herein by reference in their entirety. If a plurality of definitions for terms exists, those in this section prevail. If reference is made to a URL or other such identifier or address, it is understood that such identifier(s) can change and particular information on the Internet can change as well, so that equivalent information can be found by Internet searches. Reference thereto evidences the availability and public dissemination of such information.

Any methods, devices, and/or materials similar or equivalent to those described herein can be used in the practice or testing of the present invention; however, representative methods, devices, and/or materials are now described.

The present invention is based, at least in part, on using carbon-containing raw materials like carbon black, starch, wood char, and biomass-derived sugars as raw material for carbon-encapsulated metal-core nanoparticle synthesis through cost-effective thermal processes. The invention processes and methods obtain a highly active and stable catalyst that can be used, for example, in dry reforming of methane, natural gas, and biogas to syngas. More specifically, it has been determined that the invention methods can, in some embodiments, produce nickel-based nano-structured catalysts. These nickel-based nanoparticles demonstrate remarkably high activity and stability for dry reforming methane, natural gas or biogas to synthesis gas (syngas). Rates of CO₂ and methane conversion can be improved to over 95% with the activity of the catalyst staying constant after 500 hours run with commercial pipeline natural gas. No carbon deposition is observed over the catalysts, and these nano-structured catalysts exhibit sulfur-tolerance when running with raw natural gas. Nickel-based catalysts described herein are easy to regenerate and recycle; therefore, the cost of the catalysts is significantly reduced compared to the cost of catalysts that are currently commercially available.

The invention in certain embodiments provides methods for the production of tungsten carbide-based nano-structured catalysts and their use for methane dry reforming to synthesis gas (syngas). Nano-structure tungsten carbide-based catalyst compositions and their methods of use are disclosed herein, as well as techniques to maintain catalyst stability. Molybdenum-based nano-structured catalysts and methods of production and their use are also provided. The methods of producing tungsten-based nano-structured catalysts can also be used, for example, for the production of molybdenum-based nano-structured catalysts.

In some embodiments, a method for synthesizing a nanostructured catalyst is provided, which can include the steps of forming an aqueous solution including a metal salt; subsequently adding a carbon source to the aqueous solution; drying the aqueous solution to obtain a sample; and thermally treating the sample in a carrier gas to obtain a nanostructured catalyst including a metal nanoparticle.

With respect to the first step of the synthesis method, namely the provision of a metal salt and an organic carbon source to form an aqueous solution, numerous metal salts can be used in accordance with the invention methods including, but not limited to, salts of transition metals, such as molybdenum, tungsten, nickel, and the like. In some embodiments, the salts of such transition metals are water soluble such that the transition metal salts can be included in an aqueous solution. For example, and as described in further detail below, in certain embodiments, nickel nitrate hexahydrate (Ni(CH₃CO₂)₂.4H₂O can first be added to water to provide an aqueous solution. Other metal salts contemplated for use in the invention include nickel nitrate, nickel sulfide, nickel sulfate, nickel carbonate, nickel hydroxide, nickel carboxylate, or nickel halide, or a combination thereof. In other embodiments, an ammonium tungstate aqueous solution can be prepared.

A carbon source, such as biochar, can then be added to the aqueous solution. The carbon source can be an organic carbon source. With respect to the carbon source, the term “carbon source” is used herein to refer to various water soluble organic materials serving as a source of carbon for the production of the carbide catalysts. Numerous organic carbon sources can be used in this regard and can, in certain embodiments, be selected from sources such as wood char, carbon black, starch, biomass-derived sugars, and biochar, lignin, and other biomass-derived carbon materials. The wood char can be from any desirable source, including, in some embodiments, pine char.

In some embodiments, the carbon source is treated prior to use. For example, in some embodiments, the carbon source is biochar, which is treated prior to being added to the aqueous solution. In some instances, the biochar can be boiled in an acid solution overnight or for a sufficient amount of time to remove any soluble alkali ions, alkaline earth ions, and bio-oil residue. In some embodiments, the acid is nitric acid. In some instances, the nitric acid solution is about 0.1M. The biochar can be subsequently washed and dried prior to use in the disclosed methods.

Regardless of the metal and carbon source selected, the metal is typically placed in aqueous solution and stirred. After an elapsed time such as, in some examples, 30 minutes, 1 hour, and up to 24 hours, the carbon source is then added to the aqueous solution in amounts sufficient to allow for the formation of carbide catalysts, also described below. The selection of a particular amount of metal and carbon source to be combined is dependent on a number of factors including the amount of catalyst to be produced, the relative carbon available in the carbon source, and the like. In some embodiments, however, the metal and the carbon source are combined such that the aqueous solution comprises an equal weight ratio of the metal salt to the organic carbon source. In some instances, the metal and the carbon source are combined such that the weight ratio of metal salt to the organic carbon source is between about 5:1 to about 1:45. In some instances, the weight ratio is about 1:1 to about 1:4. With the inversing of the ratio of metal salt to the organic carbon source, the nanoparticle size will decrease, and the outer carbon shell will be thicker. Thus, one of ordinary skill in the art can make appropriate selection of the weight ratios according to the desired characteristics of the final product.

Once the aqueous solution including the metal salt and organic carbon source are combined in the aqueous solution, the aqueous solution is subsequently dried. Drying can be performed, for example, by placing the aqueous solution in an oven at a temperature of about 80° C. In other instances, the aqueous solution is dried in an oven at a temperature of greater than 80° C., in some instances, for example, at about 110° C. to produce an oven-dried sample.

Once the oven-dried sample has been sufficiently dried, the sample is thermally treated to obtain a metal carbide catalyst. With respect to the thermally treating step of the invention methods, the heating of the oven-dried sample can be performed at various temperatures depending on the carbon source and metal source utilized, as well as the desired properties of the nanostructured catalysts to be produced. In some embodiments, the heating step is performed at a temperature of about 900° C. In some embodiments, the carbothermal reduction is performed at a temperature range of about 900° C. to about 1100° C. In other embodiments, the temperature is about 900° C., about 1000° C., about 1100° C., about 1200° C., or about 1500° C.

In some embodiments, to allow for the proper carbothermal reduction and produce the desired nanostructured catalysts, the oven-dried sample is heated from room temperature to the carbothermal reduction temperature at a rate of about 2° C./min to about 100° C./min. In some embodiments, the rate of heating is about 10° C./min.

In some instances, to allow for rapid temperature changes, the step of thermally treating the oven-dried sample comprises placing the sample in a tubular electric resistance furnace. The thermal reduction can be performed at atmospheric pressure. Of course, it is also contemplated that, for small samples, other furnaces can be utilized while, for larger samples, the selection of appropriate furnaces can be based, at least in part, on the annealing temperature.

With further respect to the step thermally treating the sample, in some embodiments, the step of thermal treatment comprises heating the sample to a desired temperature and holding the sample at the desired temperature for a time period of about 1 hour. In some embodiments, the sample is held at the desired temperature for a time period of about 3 hours. The step of thermally treating the sample can include heating the sample for a time period of about 1 hour to about 3 hours. In some embodiments, the nanostructured catalyst size, size uniformity, and performance of the catalysts can be specifically tuned by adjusting the heating time and/or the temperature. For instance, in some embodiments, the nanostructured catalysts are produced by reducing the sample at a temperature of about 1000° C. for about 3 hours, as such a temperature and time period has been shown to produce nanostructured catalysts having a more narrow particle size range and more uniform particle size.

To facilitate the removal of gaseous reaction products, the reduction of the sample is typically performed in a carrier gas whose flow rate can be adjusted according to the processing conditions and capacity of the heating device utilized (e.g., a continuous flow of a carrier gas at a flow rate of about 50 mL/min to about 500 mL/min). In some embodiments, the carrier gas is oxygen-free. In some embodiments, the carrier gas is selected from nitrogen, hydrogen, argon, helium, neon, xenon, or combinations thereof. In some embodiments, where a combination of carrier gases is used, the molar ratio of the carrier gases is about 1:1, about 1:2, about 1:3, or about 2:3. In some embodiments, the carrier gas is high purity nitrogen. In some embodiments, the carrier gas is 5% H₂ in nitrogen.

After the completion of the thermal reduction of the sample, the invention produces a nanostructured metal carbide catalyst. The thermal treatment of the sample allows for a nanostructured carbide catalyst to be produced. In this regard, in such embodiments, the nanostructured carbide catalysts are generally stable and are protected against sintering and coke formation.

In some embodiments, the nanostructured catalysts that are produced have a diameter size between about 5 to 80 nm, and in some embodiments a diameter size between about 5 to 50 nm, about 20 to 40 nm, about 30 to 80 nm, or about 5 to 10 nm. A particular sample can have varying ranges of diameter size depending on the location in the carbon catalyst support. For example, when the carbon source is biochar, the nanostructured catalyst diameters can vary when located within the char matrix (˜5-10 nm) and when on the outer surface of the char matrix (˜30-80 nm). In some embodiments, the carbon nanocatalysts have a Brumauer-Emmett-Teller (BET) surface area surface area of about 125 to about 145 m² g⁻¹.

By producing nanostructured catalysts using the methods described herein, the produced nanostructured catalysts exhibit properties making them particularly suitable for the dry reforming of methane, natural gas, and biogas. A method of dry reforming a methane-containing gas can include a first step of synthesizing a nanostructured catalyst by forming an aqueous solution including a metal salt; subsequently adding a carbon source to the aqueous solution; drying the aqueous solution to obtain a sample; thermally treating the sample in a carrier gas to obtain a nanostructured catalyst including a metal nanoparticle; and washing the nanostructured catalyst including the metal nanoparticle to remove the metal nanoparticle and obtain the nanostructured catalyst; and a second step of exposing the methane containing gas to the nanostructured catalyst.

In some instances, the reaction temperature for the dry reforming process according to the invention can affect product yields. In some instances, the reaction temperature for methane dry reforming is greater than about 600° C., greater than about 650° C., greater than about 700° C., greater than about 750° C., greater than about 800° C., or greater than about 900° C.

In some instances, varying the GSHV is desirable to affect feed conversion and H₂/CO molar ratio in syngas. In some embodiments, the GSHV is between about 4000 h⁻¹ and 12000 h⁻¹. In some embodiments, the GHSV is about 4000 h⁻¹ to about 6000 h⁻¹. The higher the GHSV, the higher the contacting time, and the GHSV can be adjusted to optimize the contact time needed to achieve a desired H₂/CO ratio.

In some methods of dry-reforming with the nanostructured catalysts of the invention, the molar feed ratio of CH₄/CO₂ can be adjusted to optimize performance. In some instances, the ratio is between about 0.8 to about 1.2. In some preferred embodiments, the ratio is 1.2. In most instances, the CH₄/CO₂ ratio can be adjusted to control the H₂/CO ratio for syngas production. In some instances, the desired H₂/CO ratio to be achieved is 1, and can be achieved by an adjustment in the CH₄/CO₂ ratio, as described in more detail herein. In most instances, it is desirable to optimize the conversion of CO₂ to be as high as that of CH₄ and a ratio of H₂/CO of one (1.0).

The invention is further illustrated by the following specific but non-limiting examples.

### EXAMPLES

Disclosed herein is a scalable method of producing nanostructured catalysts. The method was used to fabricate materials that exhibited high stability in their use as a catalyst for dry reforming of methane to syngas. As described below, nanostructured catalysts were synthesized via carbothermal reduction of metal-promoted carbon sources. Heating the metal-promoted samples at temperatures of around 900-1000° C. led to formation of highly stable nanostructured catalysts. Increasing the reaction time provided more uniformly-sized nanostructured catalysts. The nanostructured catalysts were evaluated to determine the efficiency of the individual catalysts in natural gas reforming.

The samples were comprehensively studied in terms of their structure, composition, and chemistry using various characterization techniques, including electron microscopy, XRD. Temperature programmed tests were utilized to investigate dry reforming reactions and catalyst performance. The techniques allowed for temperature, surface coverage, and reaction rate to vary with time, providing information and insight not available from steady-state experiments.

In addition, a series of experiments were conducted to better understand the effects of various variables on the catalysts' performance in dry reforming natural gas and in catalyst stability. Catalyst stability and retained activity at 850° C. for a period of over 500 hours indicated production of highly-stable catalysts for use in dry reforming of methane that showed no signs of sintering or coking on the nanostructured catalyst.

### Example 1: Production of Nickel Nanostructured Catalysts

### Materials and Methods

### Example 1A

Nickel promoted pine char was prepared by an impregnation method. Approximately 281.0 grams of nickel nitrate hexahydrate (Ni(NO₃)₂*6H₂O (from Sigma-Aldrich) were first added to 500 mL DI water in a 1000 mL glass beaker and stirred for 30 minutes, followed by adding 500.0 grams pine char to the nickel nitrate solution and stirred for 30 minutes. The mixture was kept at room temperature for 24 h, and then transferred to an oven where it was dried at 110° C. for one day. Fifty grams (50 g) of the nickel-impregnated pine char were packed in the middle of a 1-inch OD quartz tubular reactor. The quartz reactor was heated by a tubular electric resistance furnace. The carrier gas was introduced at a flow rate of 500 mL/min. The runs were made at atmospheric pressure and at a temperature of 900° C. The carrier gas was high purity nitrogen (99.999% purity). After the furnace was held at the desired temperature for 1 hour, the furnace was turned off and the samples were allowed to cool to ambient temperature naturally.

### Example 1B

Vulcan XC72 carbon black from Cabot (Billerica, Mass.) with a particle size of 20-50 nm and a surface area of 254 m²/g was used as the catalyst support. Nickel-impregnated carbon black was prepared by an incipient method. Approximately 281.0 grams of nickel nitrate hexahydrate (Ni(NO₃)₂*6H₂O (from Sigma-Aldrich) were first added to 500 mL DI water in a 1000 mL glass beaker and stirred for 30 minutes, followed by adding 500.0 grams carbon black to the nickel nitrate solution and stirred for 30 minutes. The resulting carbon black paste was kept at room temperature for 24 h and then dried at 110° C. in a convection oven overnight. Thermal reduction of the oven-dried sample was performed in a 1-inch OD quartz tubular reactor. Fifty grams (50 g) of the sample were packed in the reactor and heated under a nitrogen flow (99.999% purity, 500 ml/min). The temperature was increased to 900° C. at a rate of 2° C./min and held at this temperature for 1 h. The sample was then cooled to room temperature and used for catalysis.

### Example 1C

Fifteen (15) g NiCl₂.4H₂O, and 50 g starch were dissolved in 500 mL of DI water. The pH value of the reaction solution was adjusted to 7.0 with 1 M NaOH and then stirred for 30 min. The solution was transferred into the one-gallon Parr reactor. After the autoclave was sealed, it was heated and maintained between 180° C. for 12 h. After the reaction, a brown-black product was obtained. The product was collected and washed three times with DI water and ethanol to remove soluble ions and sugar residues. The final product was oven-dried at 80° C. overnight or for a suitable period of time. The dried samples were finally loaded to a 1-inch tubular reactor and ramped by 2° C./min to 900° C. under a nitrogen flow (100 mL/min) and kept for one hour and were ready for testing in the catalytic conversion process. Twelve grams (12.0 g) of sample were obtained after calcination at 900° C.

### Comparative Example

As a comparative example, a 10% Ni/γ-Al₂O₃ catalyst was produced. For this purpose, nano-structured γ-Al₂O₃ from Sigma-Aldrich with a particle size of 30-50 nm and a surface area of 300 m²/g was used as the catalyst support. Nickel-impregnated γ-Al₂O₃ was prepared by an incipient method. Approximately 5.62 grams of nickel nitrate hexahydrate (Ni(NO₃)₂*6H₂O (from Sigma-Aldrich) were first added to 20 mL DI water in a 100 mL glass beaker and stirred for 30 minutes, followed by adding 10.0 grams γ-Al₂O₃ to the nickel nitrate solution and stirred for 30 minutes. The resulting γ-Al₂O₃ paste was kept at room temperature overnight and then dried at 110° C. in a convection oven for 12 hours. Thermal reduction of the oven-dried sample was performed in a 1-inch OD quartz tubular reactor. Five grams (5 g) of the sample were packed in the reactor and heated under an air flow (50 mL/min). The temperature was increased to 500° C. at a rate of 2° C./min and held at this temperature for 3 h. The sample was then cooled to room temperature and used for catalysis.

### Nickel Catalyst Testing:

To determine the efficiency of the individual catalysts in natural gas reforming, the individual catalysts (i.e. the catalysts from Example 1A to Example 1C and from the comparative example were tested by a fixed-bed reactor, ½-inch ID, 24 inches in length, and constructed of 316 stainless-steel. The reactor accommodated a catalyst bed volume of up to 16 cm³. The reactor was packed with 20 mesh quartz chips and 3 g of catalyst prepared in Examples 1A to 1C and the comparative example. A thermowell located at the center of the reactor allowed the placement of the thermocouples to monitor the temperature of the catalyst bed. The pressure of the reactor was controlled by a back pressure regulator. The reactor was first purged with N₂ at a flow rate of 100 mL/min at room temperature for 30 min. Then the sample was reduced at 800° C. in a 50% H₂/N₂ flow of 100 mL/min for 3 h. The gas flows were metered using Brooks mass flow controllers. The product stream from the reactor was passed to a gas-liquid separator, where the temperature was lowered using a coolant (0° C.). The gas phase product from the condenser was then passed through a back pressure regulator and separated into two streams. One stream passed through a wet-test flow meter. The other stream flowed into the on-line GC auto-sampling valve with a flow rate of 25 mL/min.

The analysis of the gas phase product was carried out with an on-line Agilent 7890 gas chromatograph equipped with five packed columns coupled with three detectors, i.e., the front flame ionization detector (FID), back thermal conductivity detector, and aux thermal conductivity detector. The columns are: column#1(Hayesep T 0.5 m×⅛″ 80-100 mesh), column#2 (Hayesep Q 0.5 m×⅛″ 80-100 mesh), column#3 (Molsieve 13×1.5 m×⅛″ 80-100 mesh), column#4 (Hayesep Q 1.0 m×⅛″ 80-100 mesh), and column#5 (Molsieve 5 A 1.0 m×⅛″ 60-80 mesh). Samples from the reactor were injected into the GC through the gas sampling valve outfitted with a 1 mL sample loop. The temperature protocol employed for analysis was an oven temperature of 50° C. (maintained for 9 min), and ramped to 80° C. at a rate of 8° C./min. The TCD detectors were maintained at 175° C., while the FID detector was running at 250° C. with a hydrogen flow rate of 40 mL/min and an air flow rate of 350 mL/min. The data obtaining for each reaction temperature was recorded three times, and the obtained average values were used as the experimental results and the standard deviations were almost zero. The conversion (X_{CH}_{₄} and X_{CO}_{₂}) was defined as the CH₄ and CO₂ converted per total amount of CH₄ and CO₂ according to Eqs. (1) and (2), respectively:

$$\begin{matrix}{X}_{{CH}_{4}} \% = \frac{{C}_{{CH}_{{4}_{in}}} - {C}_{{CH}_{{4}_{out}}}}{{C}_{{CH}_{{4}_{in}}}} \times 100 & ( 1 ) \\ {X}_{{CO}_{2}} \% = \frac{{C}_{{CO}_{{2}_{in}}} - {C}_{{CO}_{{2}_{out}}}}{{C}_{{CO}_{{2}_{in}}}} \times 100 & ( 2 )\end{matrix}$$

where Cᵢ_{ᵢₙ} is the initial molar fraction of component I in the feed, and Cᵢ_{ₒᵤₜ} the final molar fraction of component i in the gaseous effluent.

The yield of CO (Y_{CO}) is defined according to Eq. (3).

$${Y}_{CO} \% = \frac{{C}_{{CO}_{out}}}{{C}_{{CH}_{{4}_{in}}} + {C}_{{CO}_{{2}_{in}}}} \times 100 \qquad ( 3 )$$

### Results and Discussion

### Example 1A Testing

### Effect of Reaction Temperature:

The effect of the reaction temperature on catalyst activity of Example 1A nanoparticles and product yields in CH₄/CO₂ reforming is displayed in Table 1. All the data were collected under 0.1 MPa pressure. The lower the reaction temperature, the lower the CH₄ and CO₂ conversions as well as the lower CO yield, since dry reforming is an endothermic reaction. Low feed conversion (11.9% for CH₄ and 20% for CO₂) at a low temperature (600° C.) was observed. The conversion of CO₂ should be as high as that of CH₄ and the ratio of H₂/CO should be one. However, the conversion of CO₂, as listed in Table 1, was significantly higher than that of CH₄, and the H₂/CO ratio varied from 0.38 at 600° C. to 0.97 at 900° C. (Table 1).

TABLE 1
Effect of reaction temperature on feed conversion and CO yield during
CH₄/CO₂ reforming over Example 1A nanoparticles at
CH₄/CO₂ ratio of 1, and GHSV of 6,000 h⁻¹.

| Temperature | CH₄ conversion | CO₂ conversion | CO | H₂/CO |
|---|---|---|---|---|
| (° C.) | (%) | (%) | yield (%) | ratio |
| 600 | 11.9 | 20.0 | 17.5 | 0.38 |
| 650 | 19.3 | 39.81 | 35.7 | 0.49 |
| 700 | 39.6 | 50.4 | 49.5 | 0.58 |
| 750 | 52.7 | 74.6 | 73.4 | 0.65 |
| 800 | 69.4 | 89.3 | 85.6 | 0.76 |
| 850 | 88.3 | 95.5 | 92.1 | 0.86 |
| 900 | 97.6 | 99.7 | 99.5 | 0.97 |

Effect of Molar Feed Ratio of CH₄/CO₂:

The effect of molar feed ratio of CH₄/CO₂ on the CH₄ and CO₂ conversions as well as of the H₂/CO ratio over tungsten carbide nanoparticles at 850° C. is listed in Table 2. CH₄ conversion was observed to decrease with an increasing of CH₄/CO₂ ratio; whereas, CO₂ conversion increased with increasing of CH₄/CO₂ ratio. The maximum H₂ selectivity was also achieved with a high CH₄/CO₂ ratio. By introducing less CO₂ into the dry methane reforming process, desired H₂/CO ratios close to one were achieved, indicating that H₂ consumption undergoing RWGS was suppressed due to the lack of CO₂. Thus, it was vital to control the H₂/CO ratio for syngas production by adjusting the CH₄/CO₂ ratio.

TABLE 2
Effect of CH₄/CO₂ ratio on performance of Example 1B
nanoparticles at 850° C., and GHSV of 6,000 h⁻¹.

| CH₄/CO₂ | CH₄ conversion | CO₂ conversion | CO | |
|---|---|---|---|---|
| ratio | (%) | (%) | yield (%) | H₂/CO ratio |
| 1.2 | 76.7 | 100 | 80.4 | 1.00 |
| 1.1 | 81.9 | 99.99 | 87.3 | 0.88 |
| 1 | 88.3 | 95.5 | 92.1 | 0.86 |
| 0.9 | 90.7 | 92.3 | 92.0 | 0.79 |
| 0.8 | 91.5 | 89.3 | 88.4 | 0.76 |

### Effect of Gas Hourly Space Velocity (GHSV):

The effect of GHSV on feed conversion and on H₂/CO molar ratio in product is shown in Table 3. The CH₄ conversion and H₂/CO ratio decreased from 90.3% to 73.7% and 0.92 to 0.68, respectively, as the GHSV increased from 4000 to 12000 h⁻¹ over Example 1A nanoparticles. CO₂ conversion dropped slightly from 97.6% at 4000 h⁻¹ to 89.5% at 12000 h⁻¹. The results from varying the GHSV revealed that CO₂ dissociative adsorption was faster than that for CH₄ at lower GHSV, or a longer contact time, which allowed the slower CH₄ dissociation reaction to reach equilibrium. Thus, when the CO₂ dissociation and CH₄ splitting reaction were at equilibrium, the catalyst remained at thermodynamic equilibrium. Higher GHSV means shorter contacting time; thus, CO₂ dissociative adsorption dominated on the catalyst surface, and the reactant (CH₄) of the slow process (dissociation reaction) had less opportunity to diffuse into the active sites.

TABLE 3
Effect of GHSV on performance of Example 1A nanoparticles
at 850° C., and CH₄/CO₂ ratio of 1.

| GHSV | CH₄ conversion | CO₂ conversion | | |
|---|---|---|---|---|
| (h⁻¹) | (%) | (%) | CO yield (%) | H₂/CO ratio |
| 4000 | 90.3 | 97.6 | 93.7 | 0.92 |
| 6000 | 88.3 | 95.5 | 92.1 | 0.86 |
| 8000 | 80.3 | 93.0 | 82.8 | 0.78 |
| 10000 | 76.3 | 91.0 | 76.2 | 0.72 |
| 12000 | 73.7 | 89.5 | 71.7 | 0.68 |

### Stability of the Example 1A Catalyst:

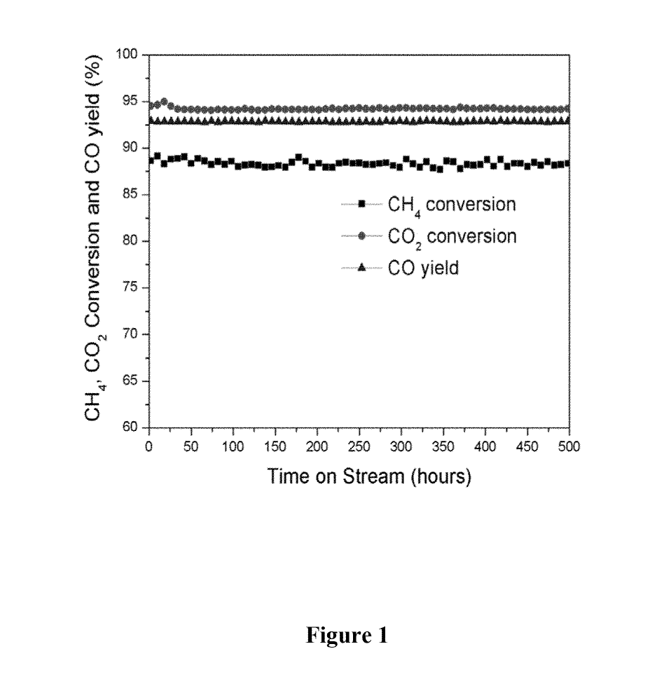

The stability of Example 1A nanoparticles was tested at 850° C., 0.10 MPa, GHSV of 6000 h⁻¹ and a constant feed (CH₄/CO₂) ratio of 1 (FIG. 1). The CH₄ and CO₂ conversions increased steadily during the first 20 hours at 850° C. and then stabilized at 95% and 88%, respectively, with a CO yield of 92% and the H₂/CO ratio in the 500-hours running kept around 0.85-0.93. The catalyst was found to be very stable at 850° C. for a period of over 500 hours. In FIG. 1, the lifetime test of methane dry reforming over the Example 1A nanoparticle at 850° C., GHSV of 6000 h⁻¹ and a constant feed (CH₄/CO₂) ratio of 1 is depicted.

### Stability of Example 1A Using Raw Natural Gas:

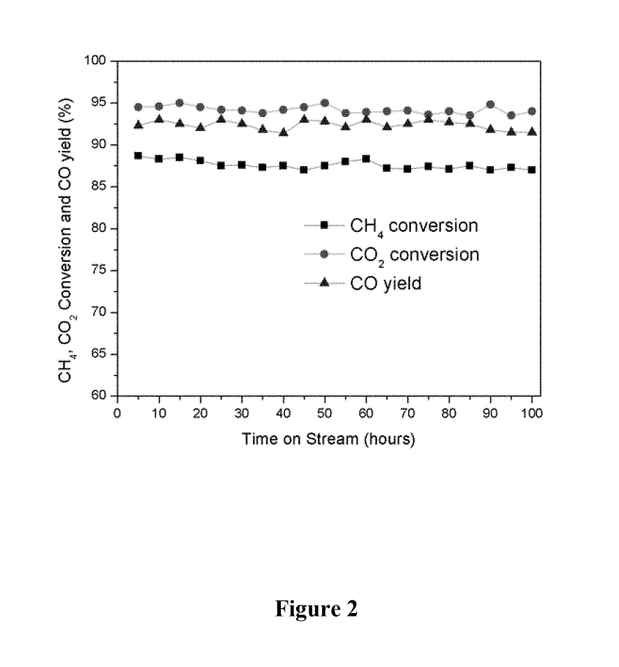

The stability of Example 1A nanoparticles was tested at 850° C., 0.10 MPa, GHSV of 6000 h⁻¹ and a constant feed (CH₄/CO₂) ratio of 1 when using raw natural gas. The results are plotted in FIG. 2. The CH₄ and CO₂ conversions were observed steadily during the 100 hours run at 850° C.

### Example 1B Testing

The effect of the reaction temperature on catalyst activity of Example 1B nanoparticles and product yields in CH₄/CO₂ reforming is listed in Table 4. All the data were collected under 0.1 MPa pressure. It was observed that CO₂ conversion was higher than that of CH₄ at a temperature below 650° C., while CH₄ conversion was higher than that of CO₂ when the temperature was above 700° C.

TABLE 4
Effect of reaction temperature on feed conversion and CO yield
during CH₄/CO₂ reforming over Example 1B nanoparticles
at CH₄/CO₂ ratio of 1, and GHSV of 6,000 h⁻¹.

| Temperature | CH₄ | CO₂ | CO yield | |
|---|---|---|---|---|
| (° C.) | conversion (%) | conversion (%) | (%) | H₂/CO ratio |
| 600 | 18.9 | 20.0 | 18.5 | 0.88 |
| 650 | 29.1 | 30.81 | 30.9 | 0.93 |
| 700 | 69.6 | 65.4 | 69.5 | 0.99 |
| 750 | 78.7 | 74.3 | 75.7 | 1.01 |
| 800 | 89.4 | 85.3 | 86.6 | 1.06 |
| 850 | 98.3 | 95.5 | 95.5 | 1.08 |

### Stability of the Example 1B Catalyst:

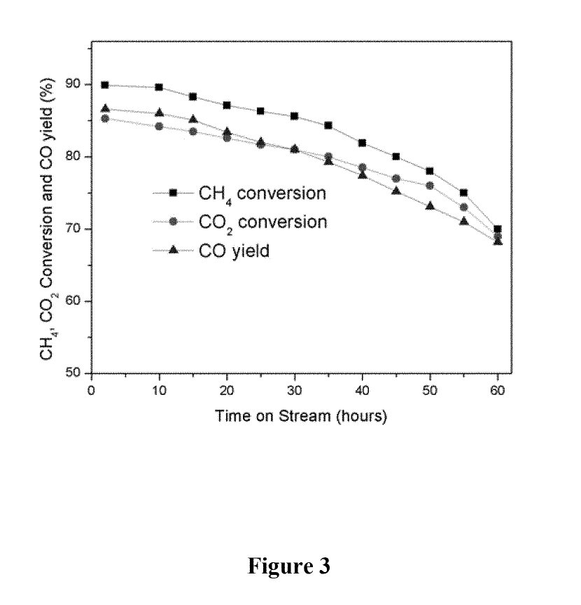

The stability of Example 1B nanoparticles was tested at 800° C., 0.10 MPa, GHSV of 6000 h⁻¹ and a constant feed (CH₄/CO₂) ratio of 1, as shown in FIG. 3. The CH₄ and CO₂ conversions decreased with time-on-stream. The catalyst was found to be very unstable at 800° C. for a period of 60 hours running. CH₄ and CO₂ conversion reduced from 90% and 85.3% to 70% and 69%, respectively, after 60 hours testing. The deactivation of Example 1B might have been due to carbon formation during methane dry reforming process.

### Example 1C Testing

The effect of the reaction temperature on catalyst activity of Example 1C nanoparticles and product yields in CH₄/CO₂ reforming is listed in Table 5.

TABLE 5
Effect of reaction temperature on feed conversion and CO yield
during CH₄/CO₂ reforming over Example 1C nanoparticles
at CH₄/CO₂ ratio of 1, and GHSV of 6,000 h⁻¹.

| Temperature | CH₄ | CO₂ | CO yield | |
|---|---|---|---|---|
| (° C.) | conversion (%) | conversion (%) | (%) | H₂/CO ratio |
| 600 | 28.5 | 35.0 | 35.8 | 0.67 |
| 650 | 39.9 | 35.9 | 40.9 | 0.69 |
| 700 | 50.6 | 70.4 | 75.3 | 0.73 |
| 750 | 75.7 | 82.3 | 80.5 | 0.85 |
| 800 | 85.4 | 89.3 | 87.6 | 0.92 |
| 850 | 92.2 | 93.6 | 92.7 | 0.95 |

### Stability of the Example 1C Catalyst:

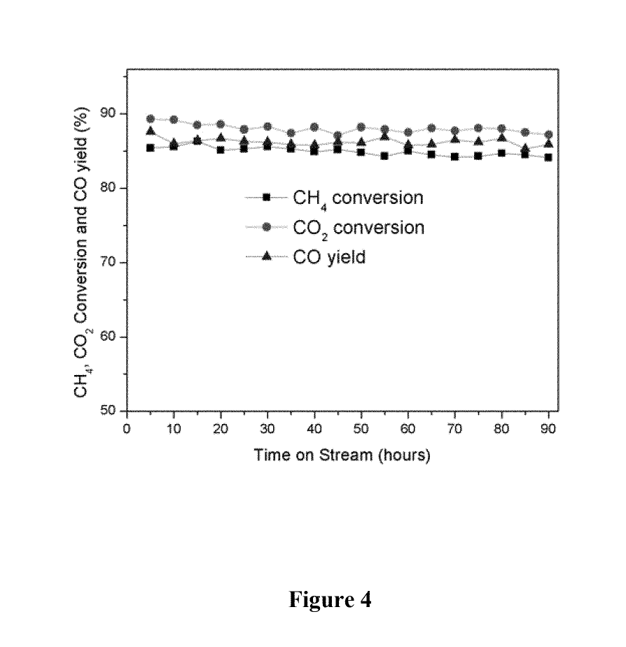

The stability of Example 1C nanoparticles was tested at 800° C., 0.10 MPa, GHSV of 6000 h⁻¹ and a constant feed (CH₄/CO₂) ratio of 1 (FIG. 4). The catalyst was found to be very stable at 800° C. for a period of 90 hours testing.

### Comparative Example Testing

The effect of the reaction temperature on catalyst activity of Comparative Example and product yields in CH₄/CO₂ reforming is listed in Table 6.

TABLE 6
Effect of reaction temperature on catalyst activity of Comparative
Example Catalyst and product yields in CH₄/CO₂ reforming feed
conversion and CO yield during CH₄/CO₂ reforming over Comparative
Example at CH₄/CO₂ ratio of 1, and GHSV of 6,000 h⁻¹.

| Temperature | CH₄ | CO₂ | CO yield | |
|---|---|---|---|---|
| (° C.) | conversion (%) | conversion (%) | (%) | H₂/CO ratio |
| 550 | 30.1 | 33.0 | 28.5 | 0.95 |
| 600 | 40.2 | 40.9 | 38.1 | 0.99 |
| 650 | 65.6 | 62.1 | 60.5 | 1.03 |
| 700 | 80.3 | 75.1 | 71.1 | 1.05 |
| 750 | 86.5 | 80.6 | 76.2 | 1.07 |
| 800 | 90.6 | 85.5 | 83.7 | 1.1 |

### Stability of Comparative Example:

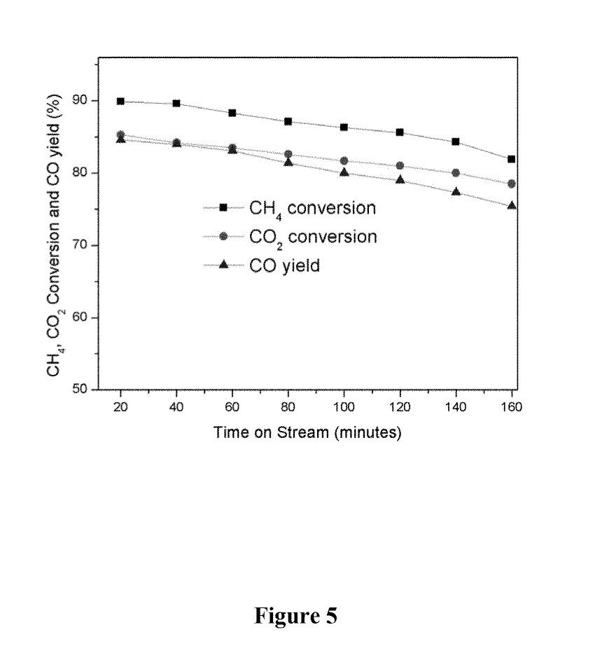

The stability of the catalyst of the Comparative Example was tested at 800° C., 0.10 MPa, GHSV of 6000 h⁻¹ and a constant feed (CH₄/CO₂) ratio of 1 (FIG. 5). The CH₄ and CO₂ conversions decreased significantly during 160 minutes testing at 800° C.

### Physical Characterization

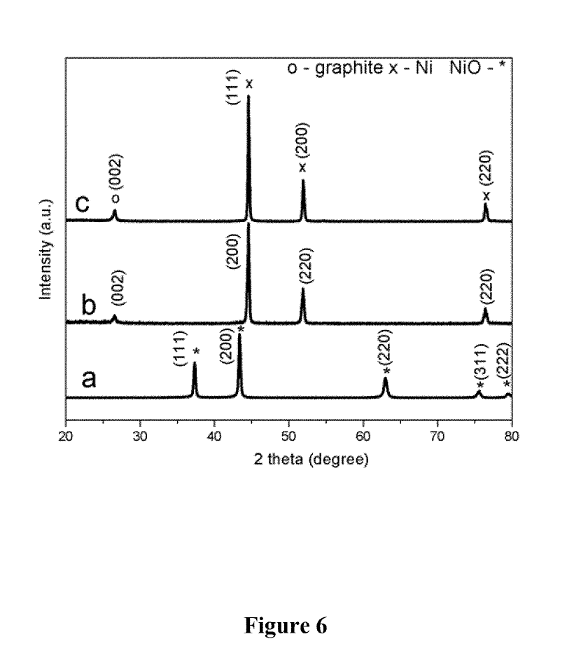

FIG. 6 shows the XRD patterns of the calcined nickel pre-impregnation char at 300° C. under an argon flow (FIG. 6a), the thermal treated nickel-promoted char at 900° C. under an argon flow (FIG. 6b), and the thermal treated nickel-promoted char after being used in catalytic conversion process (FIG. 6c). FIG. 6a exhibits peaks at 2θ=47.1°, 43.0°, 62.6°, 75.0°, and 79.0°, all characteristic of NiO, with face centered cubic (FCC) unit cell (reticular planes indexed (1 1 1), (2 0 0), (2 2 0), (3 1 1) and (2 2 2), (JCPDS card 4-835). Average particle size, calculated using the Scherrer's equation, was found to be around 40 nm. FIGS. 1b and 1c show three peaks that correspond to the (111), (200) and (220) planes of FCC Ni metal (JCPDS card file no. 87-0712). The peak at 26.55° may correspond to carbon (002) plane, which means the nickel-promoted char was graphited after the thermal treatment. In addition, there is no nickel carbide of the cementite phase detected. In accordance with above results, one can assume that nickel ions originally absorbed on char are reduced by carbon atoms and that they agglomerate to form nanoparticles. The size of the nickel nanoparticles was also estimated using the Scherer equation. The average particle size of the nickel nanoparticles was estimated as 30 nm, calculated from the Scherer equation using nickel (111) peak at 20 of 44.5°.

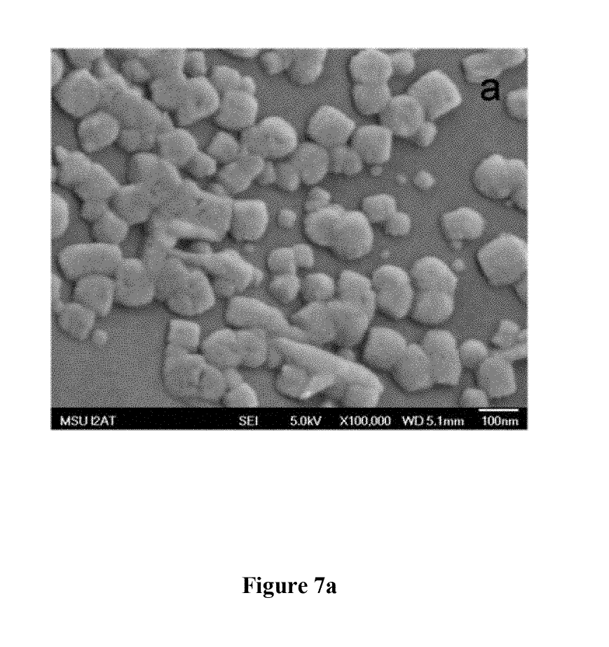

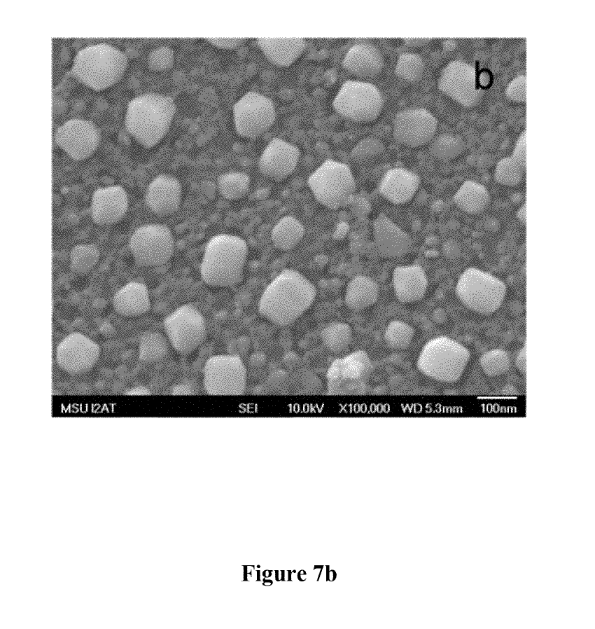

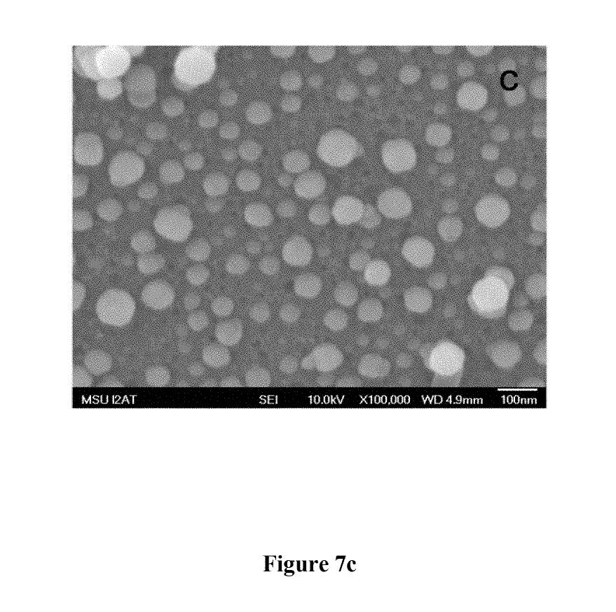

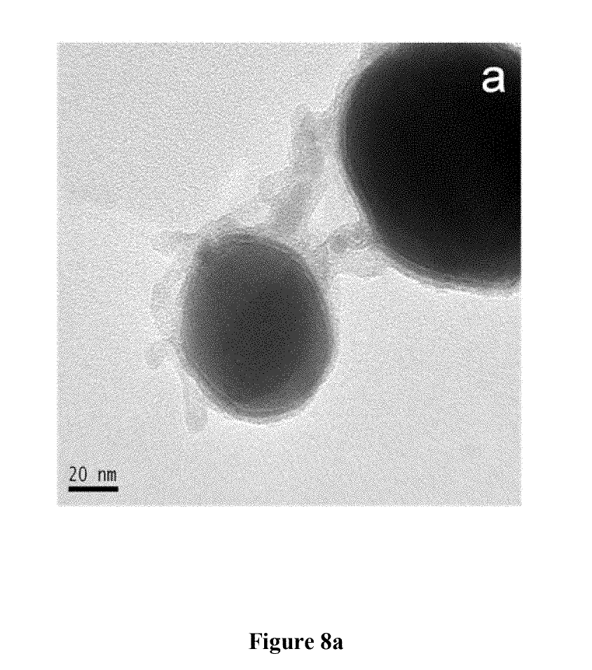

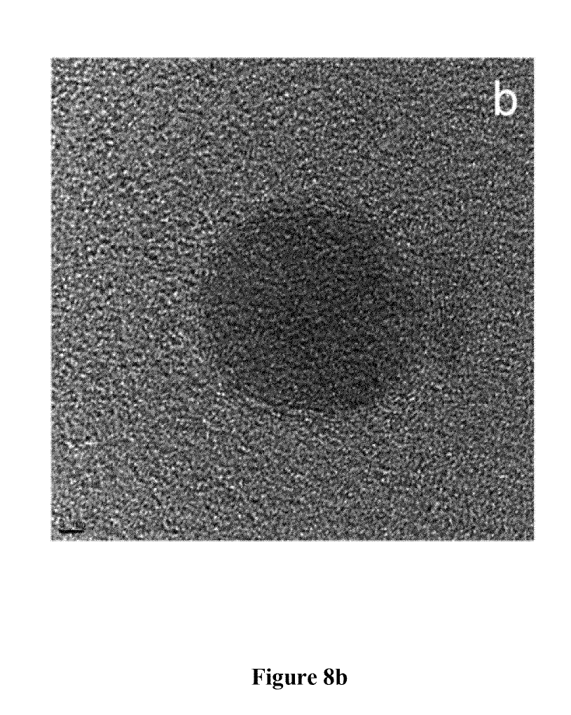

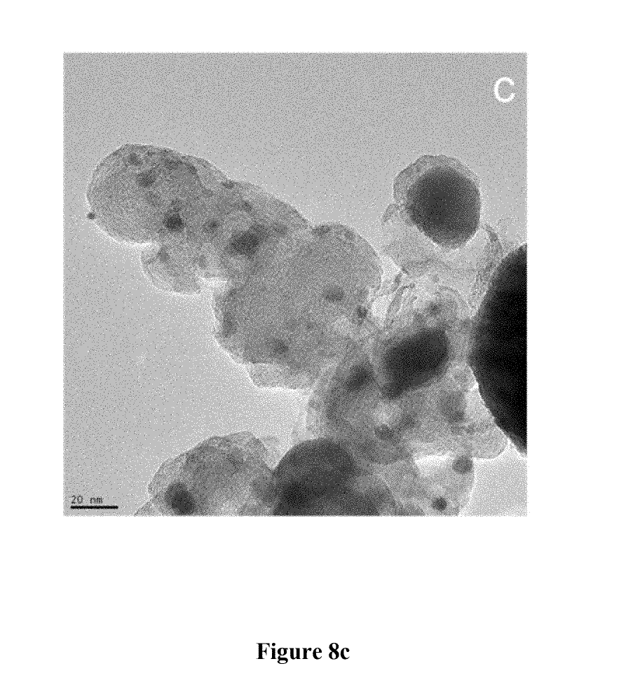

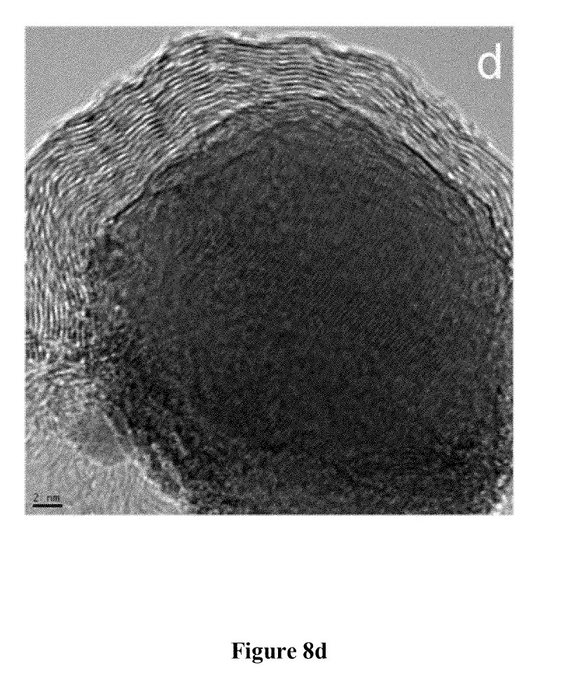

FIG. 7 shows the morphology of nickel-promoted biochar samples. FIG. 7 shows scanning electron microscope (SEM) images of calcined nickel-impregnated biochar (a), fresh thermal-treated nickel-impregnated biochar (b), and used nickel-impregnated biochar (c). SEM images show that NiO particles were distributed well on the char surface for the calcined sample, with the average size of about 30-50 nm size (FIG. 7a). It was observed that thermal treated nickel-promoted biochar surface (both the char matrix and the outer surface of the biochar) was filled with nanoparticles (FIG. 7b). The nanoparticles in the char matrix ranged between 5 and 10 nm in diameter while the particles on the outer surface were between 30-80 nm. These nanoparticles did not change much after methane dry reforming for 10 hours (FIG. 7c). Thermal-treated nickel-promoted char samples were soaked in the absolute ethanol solution, followed by sonicating the mixture for 20 min. The suspended particles washed off from the char surface were collected for TEM characterization. Typical TEM images of nickel-promoted biochar after carbothermal reduction at 900° C. are shown in FIGS. 8a and 8b. Samples treated by carbothermal reduction at 900° C. for 1 hour consisted of nickel nanoparticles (FIG. 8a), with particle sizes of ˜30-50 nm. TEM images further showed that thermal treated nickel-promoted biochar after dry reforming of methane at 850° C. for 10 hours was also composed of nickel nanoparticles (FIG. 8c), but the particles had size ranges of 5-50 nm. TEM results agreed with the previous SEM images (FIG. 8c). Most nickel nanoparticles were wrapped by a graphene layer after thermal treatment and methane dry reforming (FIGS. 8b and 8d). The metallic core was encapsulated in polyhedral concentric graphene shells with a varying number of layers. This agreed with XRD patterns of carbon encapsulated nickel particles that were formed after thermal treatment, where both the graphite and nickel metal were detected.

### Temperature-Programmed Thermal Treatment

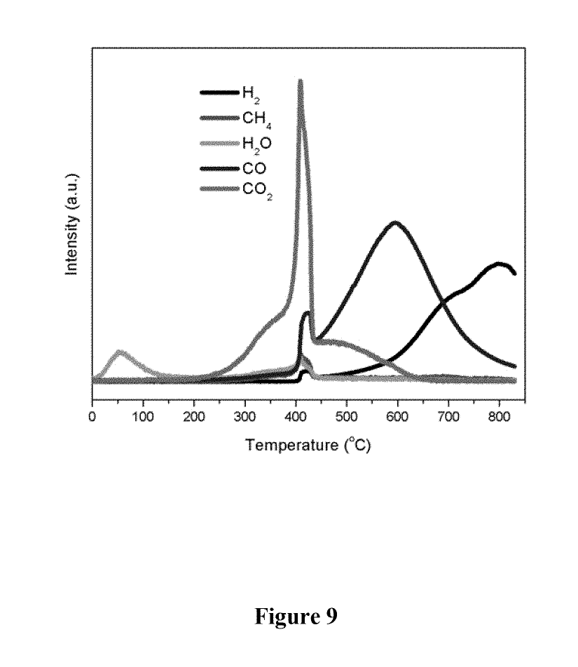

FIG. 9 shows the trends of purging gas species during temperature-programmed thermal treatment of the nickel doped char sample. TPD curves were significantly different compared to those of the unpromoted char. The CO peak of 600° C. corresponding to phenols was not noticeably changed, but the CO peak (700° C.) assigned to ether disappeared. This implies that doped nickel ions promote the hydrolysis of the ether. There is a sharp CO₂ peak at 430° C. that is assigned to the carbothermal reduction of nickel oxide. Hydrogen evolution was observed when the temperature was above 500° C., probably due to graphitization of the char material promoted by nickel metal. In the present work, this explained the nickel-catalyzed bio-char carbonization results. Nickel oxide dissolved in the char matrix may first be reduced by surface functional groups of the char. The reduced metallic nickel then reacted with amorphous carbon to form a graphite shell:

NiO+active functional groups→Ni+CO₂+CO+H₂O

Ni+amorphous carbon→Ni@C

### Temperature-Programmed Reaction

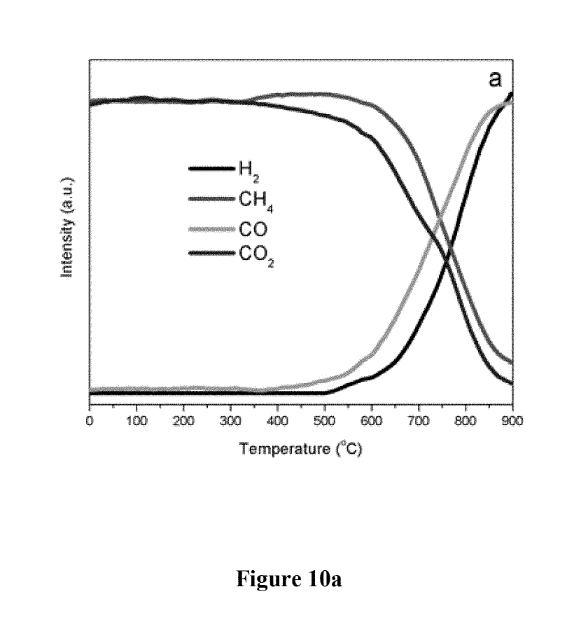

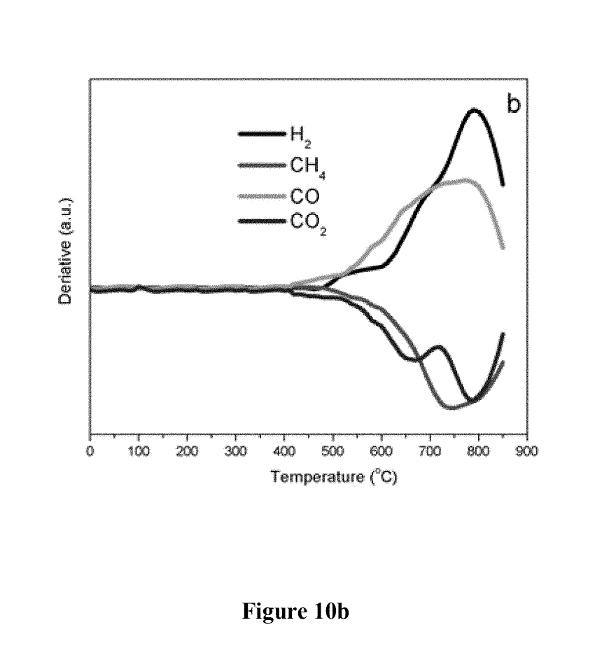

The complex system of dry reforming reactions by temperature programmed tests was investigated. In these methods, the flow of the reagents/products was recorded as a function of the temperature linear increase. The transient nature of a TPR technique, in which temperature, surface coverage, and reaction rate all vary with time, allows to provide information that are not available from steady-state experiments. FIG. 10a shows the results of the catalytic activity during CH₄/CO₂ temperature-programmed reaction for the thermal-treated nickel-impregnated biochar. Mass spectrometry signals of the effluent gases are displayed versus temperature. As can be seen, CO₂ begins to convert to CO from 350° C. Only CO appears while the CO₂ intensity decreases between 350 and 500° C., and no hydrogen is detected in this temperature zone. These results may be attributed to two possible side reactions; one is Ni—C of Ni@C oxidized by CO₂ and released as CO:

Ni—C+CO₂→Ni+2CO

Another possible route is the reverse water gas shift reaction (RWGS):

H₂+CO₂→H₂O+CO

This side effect can lead to extra consumption of H₂ and CO₂, and extra production of CO. The H₂ is mainly coming from the surface-adsorbed hydrogen on nickel surface since there is no methane consumed in the reaction temperature of 350-500° C. Methane starts to consume and hydrogen is formed after 500° C. The methane conversion is always lower than the CO₂ conversion, although they are present in the feed in a 1:1 ratio. This is assigned to the coincident occurrence of the reverse water-gas shift reaction (RWGS).

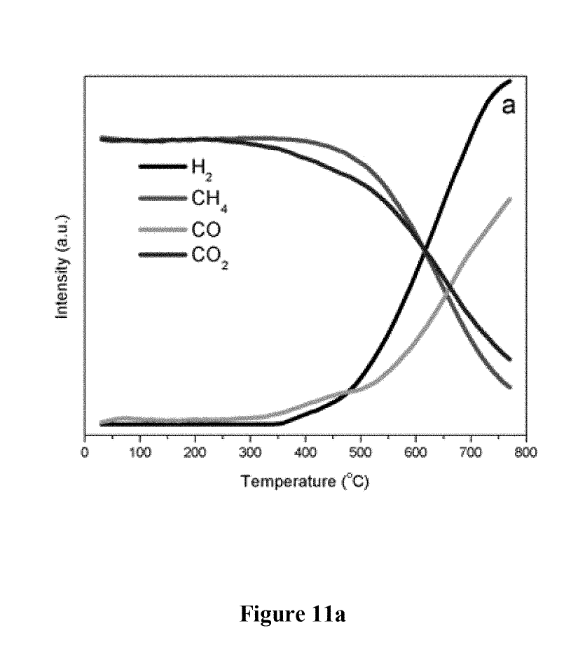

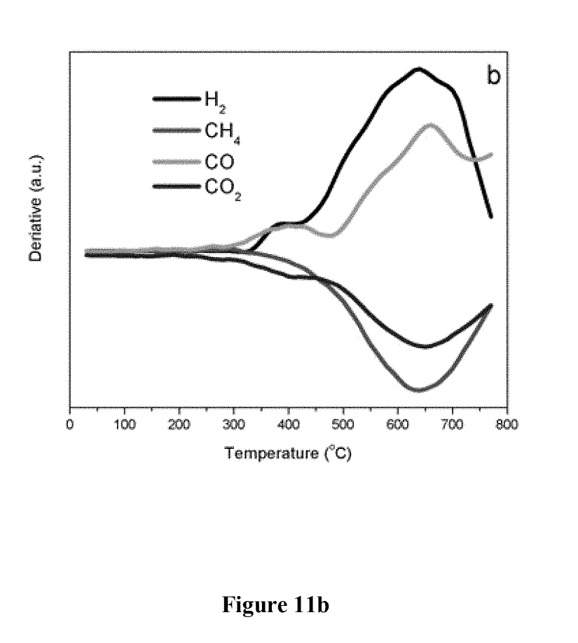

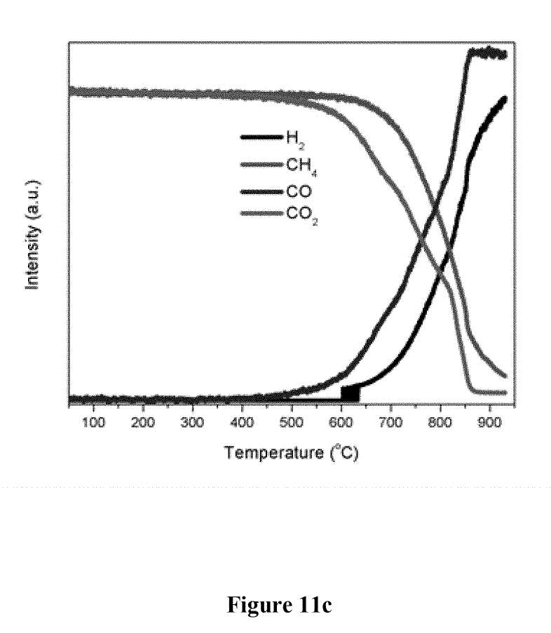

For comparative purposes, the TPR process was also studied over 10% Ni/γ-Al₂O₃ catalyst (FIG. 11). FIGS. 11a and 11b curves show the concentration of H₂, CH₄, CO, and CO₂, versus temperature obtained over Ni/γ-Al₂O₃ sample. The reaction started at around 350° C. and it was completed around 800° C. Both CH₄ and CO₂ begin to diminish from 350° C. while H₂ and CO increase with elevating of temperature. Raising the reaction temperature further induced a continuous increase of conversion of both reactants.

From the evidence presented it appeared that the mechanisms over both catalysts were different; the reforming reactions over Ni@carbon can occur via a redox type mechanism. However, there were two possible competing mechanisms for the formation of synthesis gas. At low temperature zone, the first was the cycling or redox mechanism, and the second was a noble metal type mechanism at high temperature. In the redox type route, depicted below, it is proposed that after dissociative adsorption of CO₂, the O* produced reacts with carbon in the nickel-carbon interface (C(s)) to form CO. This was then filled with either C*, from methane, retaining the carbide, or O*, a first step in the oxidation to NiO:

CO₂═O*+CO

Ni—C+O*═Ni+CO

CH₄═C*+2H₂

Ni+C*═Ni—C

Ni+O*═NiO

The O*, however, can also react with C* formed from the dissociation of methane, instead of carbon from the Ni—C of Ni@C. Methane dry reforming reaction on the Ni/γ-Al₂O₃ is the basis of the second one, i.e., the noble metal mechanism. The steps are:

CH₄═C*+2H₂

CO₂═O*+CO

C*+O*═CO

### Example 2: Preparation of Tungsten-Promoted Biochar

Tungsten-promoted biochar was prepared using the impregnation method. The char used was prepared by a typical fast pyrolysis process of pine wood for bio-oil production. The biochar was first boiled in a 0.1 M HNO₃ solution overnight, or for a suitable amount of time, to remove any soluble alkali ions, alkaline earth ions and bio-oil residue, and then washed three times, or a suitable amount of times, using hot deionized (DI) water, followed by drying in an oven at 105° C. overnight or for a suitable amount of time. An ammonium tungstate [(NH₄)10H₂(W₂O₇)₆, Sigma-Aldrich] aqueous solution was prepared by adding 20 g (NH₄)10H₂(W₂O₇)₆ to 200 mL DI water. The mixture of (NH₄)10H₂(W₂O₇)₆ and DI water was heated to 80° C. and a clear solution was obtained. Approximately 20 g biochar was added to the solution and stirred at 80° C. for 30 minutes. It was then transferred to an oven where it was dried at 110° C. for one day.

### Preparation of Molybdenum-Promoted Biochar

Molybdenum-promoted lignin was also prepared by an impregnation method. Approximately 46.4 grams of ammonium molybdate tetrahydrate ((NH₄)₆Mo₇O₂₄*4H₂O from Sigma-Aldrich) were added to 200 mL DI water in a 500 mL glass beaker, stirred for 30 minutes, followed by adding 100 g pre-purified pine char to the solution and stirring for 2 hours. The mixture was kept at room temperature for 24 h, and then transferred to an oven where it was dried at 110° C. for one day.

### Carbothermal Reduction (CR) of Tungsten-Promoted Bio-Char Samples

Fifteen grams (15 g) of tungsten-promoted biochar was packed in the middle of a 2.54 cm OD, quartz tubular reactor. The quartz reactor was heated with a tubular electric resistance furnace. The carrier gas was introduced at a flow rate of 50 mL min⁻¹. The runs were carried out at atmospheric pressure and 1000° C. The carrier gas was high purity nitrogen (99.999% purity). After the furnace was held at the desired temperature for 3 hours, the furnace was turned off and the samples were allowed to cool to ambient temperature.

### Temperature-Programmed Carbothermal Reduction (TPCR)

To study the carbothermal reduction process, temperature-programmed carbothermal reduction (TPCR) was performed from room temperature to 1100° C. at a heating rate of 10° C. min⁻¹. About 10 g of the sample was employed in each run. A high purity nitrogen flow of 20 mL min⁻¹ was used as the carrier gas during the TPCR process. An Agilent 5975C on-line mass spectrometer (MS) was used for detection of the gases released from the sample bed during the TPCR process.

### Thermogravimetric Analysis (TGA) Experiments

The thermal decomposition of biochar and tungsten-promoted biochar samples was analyzed using TGA in nitrogen. The reactivity measurement of the samples was carried out using a TGA (Shimadzu TGA-50H) through isothermal analyses. The system quantitatively measured the change in mass of a sample as a function of temperature, up to 1500° C. The change in mass was then related to the changes taking place in the sample during calcination. For each sample prepared, N₂ (99.999% purity, 50 mL min⁻¹) was used at a flow rate of 50 mL min⁻¹ as the temperature was ramped at 10° C. min⁻¹. Each test was repeated at least three times.

### Analysis and Characterization

The C, H, and N elemental compositions of the biochars and catalyst samples were analyzed on a CE-440 elemental analyzer. At least three measurements were conducted for each sample. Mineral analysis was conducted on an ICP spectrophotometer (Optima model 4300 DV, PerkinElmer Instruments). The biochar samples were combusted in air and the ash was extracted with weak acids. The extracted solution was then used for ICP analysis. The physical properties of the biochar and catalyst samples were determined by N₂ adsorption-desorption (Quantachrome, Autosorb-1). Prior to measurements, the samples were degassed at 300° C. overnight.

X-ray powder diffraction (XRD) patterns of the biochar samples were obtained using a Rigaku Ultima III X-ray Diffraction System operated at 40 kV and 44 mA using Cu-Kα radiation with a wavelength of 1.5406 Å, from 100 to 800 at a scan rate of 0.02° s⁻¹. The Jade powder diffraction analysis software from Materials Data, Inc. was used for both qualitative and quantitative analysis of polycrystalline powder materials. The average size of tungsten carbide particles was evaluated by the Scherrer formula from the full width at half maximum of the most intense XRD peak corrected for instrumental broadening.

The morphology of the samples was investigated with a Scanning Electron Microscope (SEM) equipped with energy diffusive X-ray spectroscopy (EDX) (JEOL JSM-6500F). This instrument was also coupled to X-ray-EDS and WDS spectrometers and Oxford Instruments INCA Energy+ software for electron beam-induced X-ray elemental analysis. All samples were pre-coated with gold before being introduced into the vacuum chamber. The system was operated with accelerating voltage of 5 kV.

The sample particle sizes were examined with a JEOL JEM-2100 Transmission Electron Microscope (TEM) operated at an accelerating voltage of 200 kV. All samples were sonicated in ethanol solution for 20 minutes before being transferred to copper grid supporters.

### Dry Methane Reforming Test

The dry reforming reaction equipment used was a fixed-bed reactor, ½ inch ID, 24 inches in length, and constructed from 316 stainless steel. The reactor accommodated a catalyst bed volume of up to 16 cm³. The reactor was packed with 3 g of WC/Biochar catalyst and diluted by 20 mesh quartz chips. A thermowell located at the center of the reactor allowed the placement of the thermocouples to monitor the temperature of the catalyst bed. The pressure of the reactor was controlled by a back pressure regulator.

The reactor was first purged with N₂ at a flow rate of 100 mL min⁻¹ at room temperature for 30 min. Then the catalyst sample was reduced at 800° C. in a 50% H₂/N₂ flow of 100 mL min−1 for 3 h. After reduction, the reactor was cooled down to ambient temperature and then fed with CH₄/CO₂ feed gases. The gas flows were metered using Brooks mass flow controllers. The product stream from the reactor was passed to a gas-liquid separator, where the temperature was lowered using a coolant (0° C.). The gas phase product from the condenser was then passed through a back pressure regulator and separated into two streams. One stream passed through a wet-test flow meter. The other stream flowed into the online gas chromatograph (GC) auto-sampling valve at a flow rate of 25 mL min⁻¹.

### Gas Composition Analysis

The analysis of the gas phase product was carried out on an on-line Agilent 7890 GC equipped with five packed columns coupled with three detectors, i.e. the front flame ionization detector (FID), back thermal conductivity detector (TCD) and aux thermal conductivity detector. The columns were as follows: column#1 (Hayesep T, 0.5 m×⅛″ 80-100 mesh), col-umn#2 (Hayesep Q, 0.5 m×⅛″ 80-100 mesh), column#3 (Molsieve 13×1.5 m×⅛″ 80-100 mesh), column#4 (Hayesep Q, 1.0 m×⅛″ 80-100 mesh), and column#5 (Molsieve 5 A 1.0 m×⅛″ 80-100 mesh). Samples from the reactor were injected into the GC through the gas sampling valve fitted with a 1 mL sample loop. The temperature protocol employed for analysis was an oven temperature of 50° C. (maintained for 9 min), and ramped to 80° C. at a rate of 8° C. min-1. The TCD detectors were maintained at 175° C., while the FID detector ran at 250° C. with a hydrogen flow rate of 40 mL min⁻¹ and an air flow rate of 350 mL min⁻¹. The data obtained for each reaction temperature was recorded three times, and the obtained average value was used as the experimental results and the standard deviations were almost zero. The conversion (X_{CH4} and X_{CO2}) was defined as the CH₄ and CO₂ converted per total amount of CH₄ and CO₂ according to Eqns. (1) and (2), respectively.

The conversion (X_{CH}_{₄} and X_{CO}_{₂}) was defined as the CH₄ and CO₂ converted per total amount of CH₄ and CO₂ according to Eqns. (1) and (2), respectively:

$$\begin{matrix}{X}_{{CH}_{4}} \% = \frac{{C}_{{CH}_{{4}_{in}}} - {C}_{{CH}_{{4}_{out}}}}{{C}_{{CH}_{{4}_{in}}}} \times 100 & ( 1 ) \\ {X}_{{CO}_{2}} \% = \frac{{C}_{{CO}_{{2}_{in}}} - {C}_{{CO}_{{2}_{out}}}}{{C}_{{CO}_{{2}_{in}}}} \times 100 & ( 2 )\end{matrix}$$

where Cᵢ_{ᵢₙ} is the initial molar fraction of component i in the feed, and Cᵢ_{ₒᵤₜ} is the final molar fraction of component i in the gaseous effluent.

The yield of CO (Y_{CO}) is defined according to Eqn. (3):

$${Y}_{CO} \% = \frac{{C}_{{CO}_{out}}}{{C}_{{CH}_{{4}_{in}}} + {C}_{{CO}_{{2}_{in}}}} \times 100 \qquad ( 3 )$$

### Results and Discussion

### Characterization of Biochar, Tungsten-Promoted Biochar, and WC/Biochar Catalysts

### Elemental, Mineral, and Physical Properties Analysis:

Elemental analysis results (Table 7) show that the C, H, and N compositions in the biochar sample were 48.1±2.1 wt %, 0.9±0.1 wt %, and 0.4±0.03 wt %, respectively. Mineral analysis results demonstrate that the raw biochar sample contains 3.5 wt % Si, 0.7 wt % Al, 0.5 wt % Ca, 0.3 wt % Mg, and 0.1 wt % K, while only 1.5 wt % Si was left in the acid-washed biochar. The Brunauer-Emmett-Teller (BET) surface area of biochar was 12.5 m² g⁻¹, and the fresh tungsten-promoted biochar and the used WC/biochar (after 500 hours testing) samples were 136.8 and 145.2 m² g⁻¹, respectively.

TABLE 7
Elemental analysis results of biochar, fresh tungsten-promoted
biochar and used WC/biochar samples (wt %)

| | Carbon | Hydrogen | Nitrogen | Remaining |
|---|---|---|---|---|
| Samples | (%) | (%) | (%) | (%) |
| Raw biochar | 48.1 ± 2.1 | 0.9 ± 0.1 | 0.4 ± 0.03 | 49.2 |
| Acid-washed biochar | 49.5 ± 1.5 | 0.9 ± 0.2 | 0.4 ± 0.05 | 49.8 |
| Fresh tungsten- | 78.2 ± 3.6 | — | — | 23.7 |
| promoted biochar | | | | |
| WC/biochar after | 77.3 ± 2.5 | — | — | 24.1 |
| 500 hours testing | | | | |

### X-Ray Diffraction (XRD):

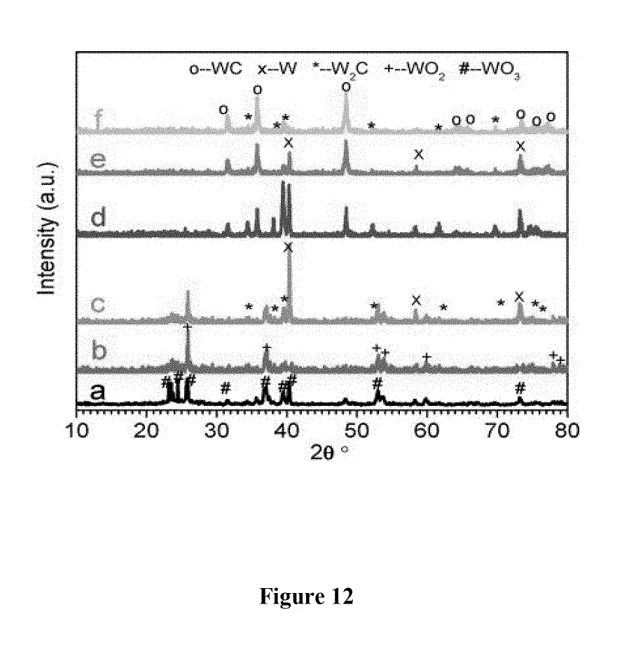

FIG. 12 shows the XRD patterns of tungsten-promoted biochar samples with tungsten loading of 20 wt % by carbothermal reduction. WO₃ (JCPDS no. 72-0677) in the biochar matrix (FIG. 12a) was first reduced to tungsten oxide (WO₂) during carbothermal reduction at 700° C. XRD patterns of the samples with carbothermal reduction at 700° C. (FIG. 12b) give typical diffraction peaks at 20° of 25.85, 36.80, 37.10, and 52.94, which are ascribed to WO₂ (JCPDS no. 02-0414). The XRD pattern of the sample via carbothermal reduction at 800° C. (FIG. 12c) shows sharp diffraction peaks of metallic tungsten at 20° of 40.27, 58.30, and 73.20, indicating that WO₂ is further reduced to metallic tungsten. At the same time, the weak peaks at 34.50, 38.03, 39.60, 52.3, 75.0 and 76.0° were also detected, which can be assigned to W₂C (JCPDS no. 35-0776) with a hexagonal closed-packed structure. The WO₂ diffraction peaks observed after CR reaction at 800° C. indicate that WO₂ reduction was not completed at this temperature. When the reduction temperature increases to 850° C. (FIG. 12d), the intensity of W₂C peaks increases as well, and the average particle size of W₂C is measured at about 10 nm using the Scherrer formula. At the same time, no more peaks contributed by WO₂ were detected. By further increasing the carbothermal reduction temperatures to 900° C. (FIG. 12e), new diffraction peaks at the 2θ of 31.5, 35.63, 48.30, 64.01, 73.10 and 77.100 with the corresponding d-spacing values of 2.8431, 2.5170, 1.8813, 1.4531, 1.2934 and 1.2360 were observed due to W (JCPDS no. 04-0806) and W₂C.

When the temperature was increased to 1000° C., the W phase disappeared, and the intensity of the peaks corresponding to WC (JCPDS no. 65-0939) increased (FIG. 12e). This result indicated that the carburization intensity increased with the increase in temperature. When the temperature was increased to 1000° C., the XRD patterns consist of WC peaks with a trace of W₂C phase and without any metallic tungsten. These diffraction peaks are attributed to the (001), (100), (101), (110), (111) and (102) facets of WC.

In summary, the XRD results show that the formation of WC proceeds with the formation mechanism via WO₃—WO₂—W—W₂C—WC. The average particle sizes of metallic tungsten W₂C and WC were estimated by the Scherrer formula from the full width at half maximum of the XRD peak. The average particle sizes of metallic tungsten at 800° C., W₂C at 850° C. and WC at 1000° C. are about 14, 12, and 10 nm, respectively.

### Scanning Electron Microscopy (SEM):

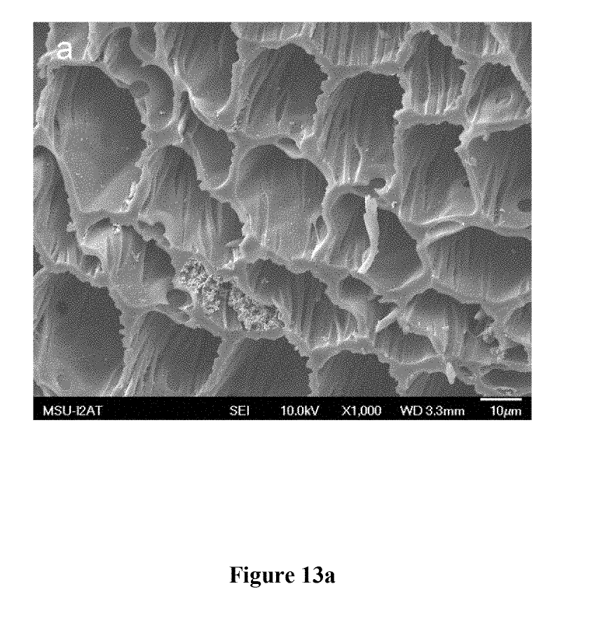

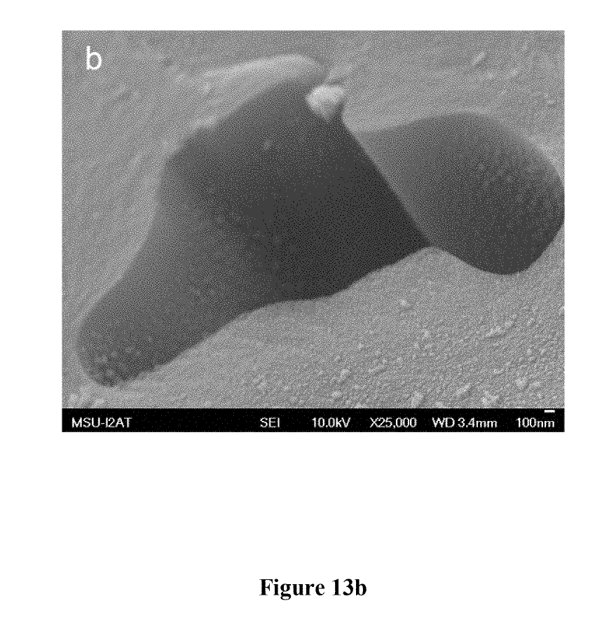

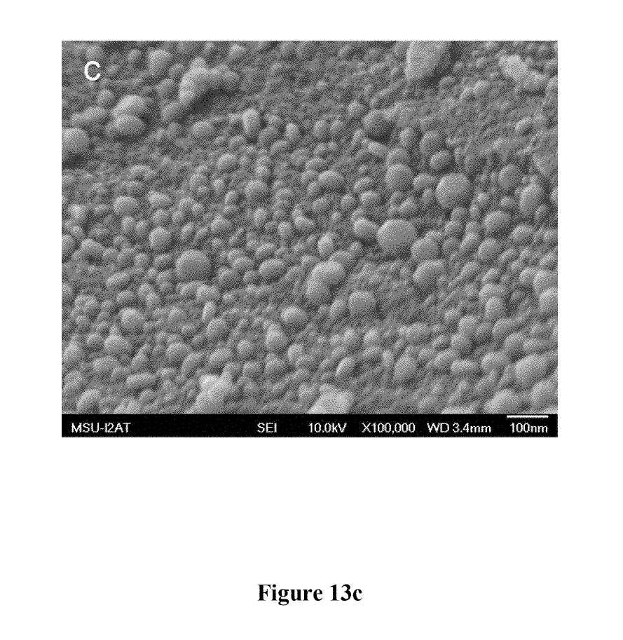

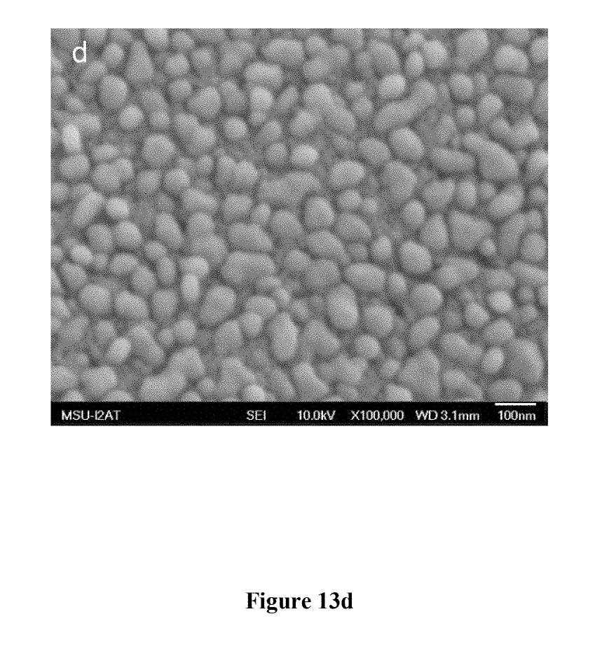

FIG. 13 shows the morphology of tungsten-promoted biochar after carbothermal reduction treatment at 1000° C. SEM images show the solid walls alongside the void vessel structure that made up the bulk of the biochar sample, which indicated that the biochar maintained much of the original structure of the pine wood (FIG. 13a). The biochar also showed highly porous and fibrous uniform vessels with channel size from 10 to 20 μm. It was observed that the wall surface (both the inner walls of the pores and the outer surface of the biochar) was filled with nanospheres (FIG. 13b). These nanoparticles ranged between 5 and 50 nm in diameter (FIG. 13c) after reduction for 1 hour. It appears that the reduction time influenced the particle size. After reduction for 3 hours at 1000° C., the particle size range was 20-40 nm (FIG. 13d), which is relatively narrow compared to that obtained with 1 hour reduction time (FIG. 13c). The more uniform particle sizes may be attributed to the tungsten carbide nanoparticle in the biochar matrix growing with increasing reduction time.

### Transmission Electron Microscopy (TEM):

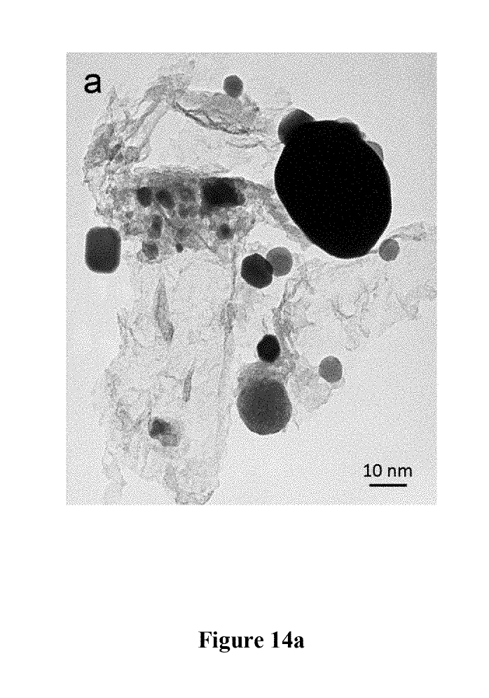

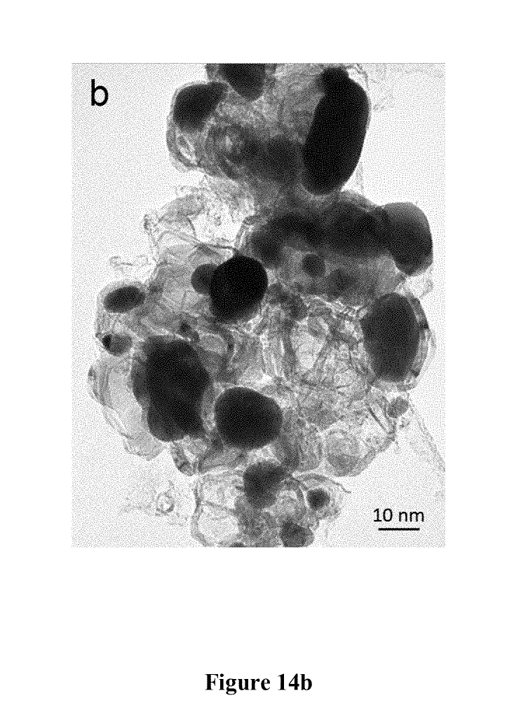

Typical TEM images of tungsten-promoted biochar after carbothermal reduction at 1000° C. are shown in FIG. 14. Samples treated by carbothermal reduction at 1000° C. for 1 hour consist of WC nanoparticles (FIG. 14a), with particle sizes of ˜5-50 nm. The TEM image further shows that tungsten-promoted biochar after carbothermal reduction treatment at 1000° C. for 3 hours was also composed of WC nanoparticles (FIG. 14b), but the particles were more uniform with a size range of 20-50 nm. TEM results agreed with the previous SEM images (FIG. 13d).

### Temperature-Programmed Carbothermal Reduction (TPCR):

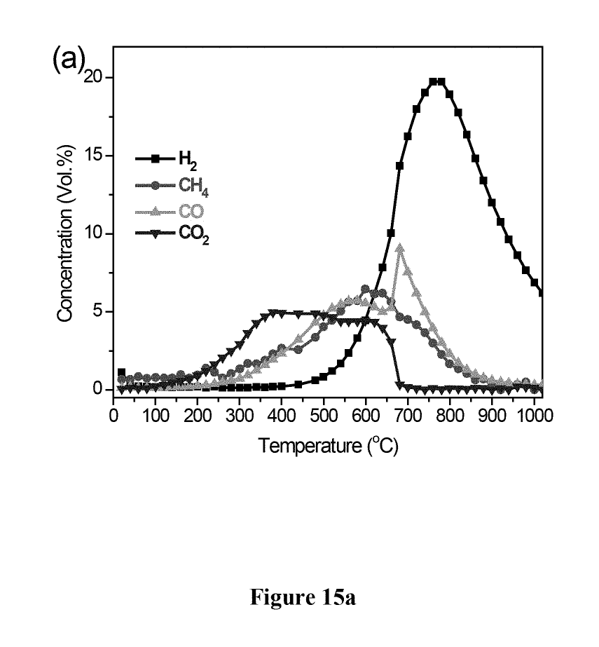

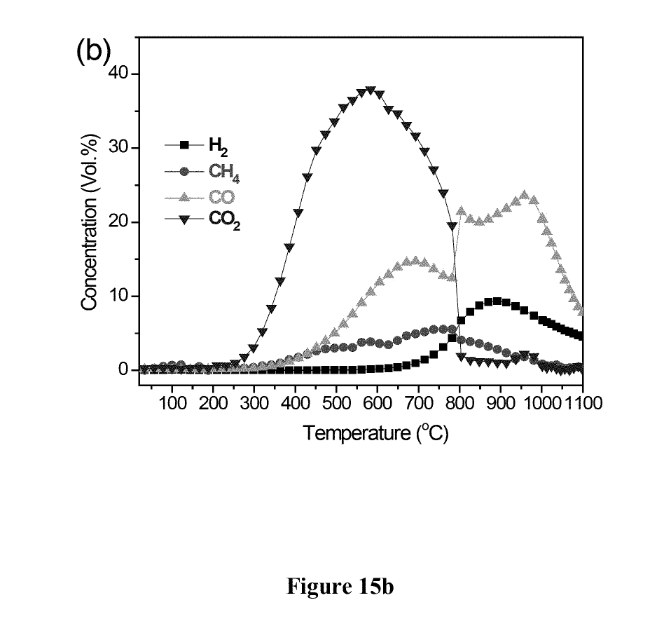

Thermal desorption profiles obtained from temperature-programmed decomposition (TPD) tests provide useful information on the types of species desorbed from the bio-char surface and on the nature of interactions between the gaseous species and carbon. FIG. 15 shows a typical TPCR curve, which records the evolution of four gaseous species (i.e. H₂, CH₄, CO₂, and CO) during thermal activation of the biochar sample. The main products were carbon oxides (i.e., CO, CO₂), and H₂O when oxygen-containing functional groups decomposed; CO and CO₂ evolution peaks of the TPD spectra indicated that most of these groups in biochar were removed after thermal treatment at 1000° C. (FIG. 15a). The corresponding peak temperatures of CO₂ desorption were 100-695° C. for carboxylic acids and anhydride groups. The corresponding peak temperatures of CO desorption centered at 590° C. for anhydride groups and the CO peak at 680° C. were assigned to carbonyls and/or ester groups. The methane peak at 600° C. was assigned to the decomposition of the higher hydrocarbons or CH₃O groups attached to aromatic and aliphatic structures. The hydrogen peak centered at 770° C. was attributed to the decomposition of CHₓ (x=1-3) groups bonded directly to carbon atoms as part of aromatic or aliphatic structures. These functional groups were beneficial to the reduction of tungsten oxides to metal and to carbide formation during the CR process.

The TPCR curves of tungsten-promoted biochar are shown in FIG. 15b. The TPCR results showed that the carbothermal reduction reaction proceeded in several stages over the temperature range studied. There was significant CO₂ formation at about 200-730° C., which suggested that WO₃ was progressively reduced to WO₂ and/or even metallic tungsten by carbon materials and/or CO formed through these possible reactions according to Eqns. (4)-(7):

2WO₃+C-2WO₂+CO₂ (4)

WO₂+C—W+CO₂ (5)

WO₃+C—WO₂+CO (6)

WO₃+CO—WO₂+CO₂ (7)

A portion of CO₂, CO, and CH₄ between 200 and 725° C. may be produced by the catalytic decomposition of CH_{X}O_{Y} groups in biochar by tungsten through the reaction of CH_{X}O_{Y}—CO+CO₂+CH₄. The major CO peak at 875° C. was attributed to the carbothermal reduction of WO₂ in the biochar matrix. The carbothermal reduction reaction includes two steps.

First, WO₂ was reduced to tungsten metal by elemental carbon on the char surface according to Eqn. (8):

WO₂+2C-->W+2CO (8)

Then, the reduced tungsten further reacted with elemental carbon to form W₂C and WC according to Eqns. (9)-(11):

2W+C-->W₂C (9)

W₂C+C-->2WC (10)

W+C-->WC (11)

Hydrogen was generated by the decomposition of CHX (X=1-3) groups bonded in the biochar structures. The maximum level of hydrogen was only 9.3%, which was only half of the hydrogen level (19.7%) during the biochar decomposition process (FIG. 15a). This finding meant that hydrogen should not be ignored in tungsten oxide reduction during the TPCR process, which is shown in Eqns. (12) and (13):

WO₃+3H₂-->W+3H₂O (12)

WO₂+2H₂-->W+2H₂O (13)

Methane was used as a carbon source in the preparation of tungsten carbide at high temperature; it is possible that some of the carbon in WC formation may have come from methane during the char carbonization process, according to Eqns. (14) and (15):

W+CH₄-->WC+2H₂ (14)

CH₄-->C+2H₂ (15)

In summary, the TPCR results agree with the XRD results that the WO₃/biochar carbothermal reduction process followed the possible reaction steps of WO₃-->WO₂-->W-->W₂C-->WC.

### Thermogravimetric Analysis (TGA) and Derivative Thermogravimetry (DTG):

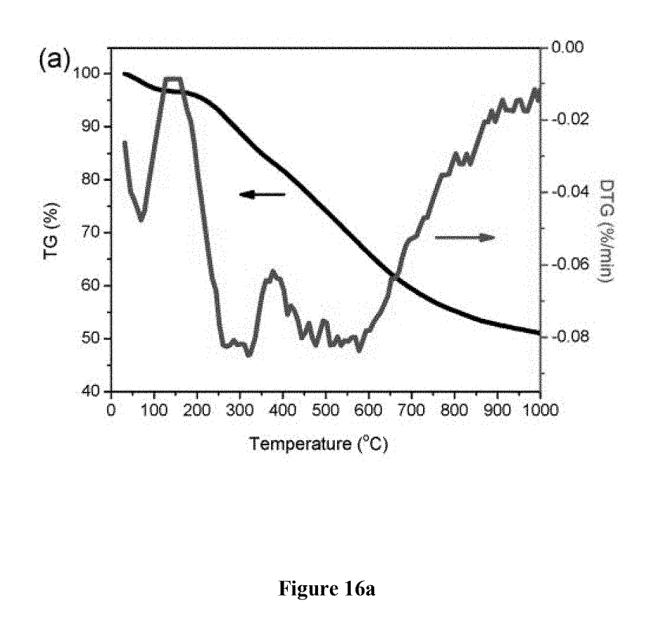

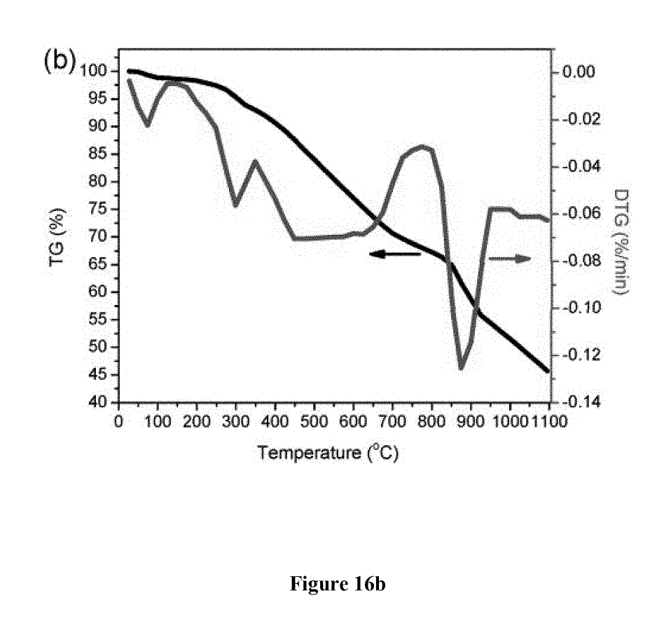

TGA and DTG data showed a continuous mass loss associated with increasing temperature, which was attributed to the breaking of chemical linkages and removal of volatile products from biochar. FIG. 16 shows the TG and DTG curves of the biochar and the tungsten-promoted biochar heated at a rate of 10° C. min⁻¹ in a N₂ atmosphere. A continuous weight loss associated with increasing temperature was observed, which may be attributed to the breaking of chemical linkages and the removal of volatile products from the biochar.

FIG. 16a indicates that there are six possible steps of weight loss of the biochar. The initial weight loss corresponded to the loss of physically adsorbed water and occurred between ambient temperature and 110° C. with a peak temperature of 70° C. It was followed by a plateau region for the rate of weight loss from 110 to 190° C. The first significant weight loss, around 190 to 350° C., corresponded to the decomposition of all the carboxylic acids and some of the carboxylic anhydrides and lactones. These results indicated that oxygen functional groups started to decompose in this temperature zone, which led to the aromatization of the biochar matrix. The largest weight loss of the biochar occurred in the temperature zone of 350 to 700° C. This mass loss step mainly corresponded to the decomposition of the rest of the carboxylic anhydrides and lactones, with parts of the phenols, quinine, and ether structures being released as volatile products, CO₂, CO, CH₄, H₂O, and H₂. The third significant mass loss occurred at 700 to 900° C. In this zone, the mass loss was mainly attributed to the decomposition of phenols, quinine, ether and C—H groups, which produced CO and H₂ as the main products. Above 900° C., the mass decreased gradually as the temperature increased to 1000° C., and only trace amounts of H₂ were released.

TGA results of tungsten-promoted biochar (FIG. 16b) were significantly different from biochar, most likely due to the promoting effect of the tungsten upon the decomposition of biochar. The highest mass loss (27.5 wt %) occurred at 150-350° C., which was about 20 wt % higher than that of biochar at that temperature range. The chemical activity of tungsten oxide could have been arising from WO₃ presented in tungsten-promoted biochar, which could react with the carbon containing functional groups of biochar and change the thermal degradation process. In this step, WO₃ was first reduced to WO₂ in the biochar matrix by the reaction according to Eqn. (16):

WO₃+C*(surface active carbon functional groups)-->WO₂+CO₂+CO+H₂O (16)

WO₂ was further reduced to W° at 780-910° C. with a peak temperature of 872° C., which is expressed in the reaction according to Eqn. (17):

WO₂+C*+CO or H₂-->W+CO₂+CO+H₂O (17)

which resulted in another significant mass loss. As mentioned above, the TPD results also demonstrated that tungsten promoted the biochar decomposition since the peak temperature of CO₂, CO, and CH₄ evolution all shifted to lower temperatures (FIG. 16b). Between 920 and 1000° C., the mass decreased gradually.

### Formation of Tungsten Carbide Nanoparticles in Biochar Matrix:

From XRD and TPCR results, it can be summarized that WO₃ was first reduced to WO₂, and then further reduced to metallic tungsten. Metallic tungsten was carburized to W₂C through the reaction with carbon species in biochar and/or biochar decay products (CO and CH₄). Finally, WC was formed through W₂C carburization.

The formation of tungsten carbide nanoparticles in the biochar matrix could be explained using a high-temperature, self-assembly growth model. In the fresh WO₃/biochar sample, WO₃ was distributed uniformly in the biochar matrix by linking to surface functional groups such as —OH and —COO— (FIG. 15). At elevated temperatures, biochar underwent thermal decomposition producing CO, CH₄, and H₂ (FIG. 15). These reducing agents diffuse in the biochar and react with WO₃ anchored in the biochar matrix (around 600° C. according to TGA results, FIG. 16b). Therefore, metallic tungsten particles would be formed first during the thermal treatment process, whereas transition metals like tungsten and molybdenum were likely to be carbonized to carbides at high temperature. The freshly-reduced tungsten nanoparticles reacted with carbon species (both the solid biochar and gaseous CO and CH₄) to form W₂C, and W₂C continued to be carburized to WC.

CH₄—CO₂ TPR Over Mo-Char Sample:

FIG. 11c curves show the concentration of H₂, CH₄, CO, and CO₂, versus temperature obtained over Mo-Char sample. The reaction started at around 400° C. and it was completed around 850° C. CO₂ began to diminish from 400° C. while CO increased with elevating of temperature. CH₄ started to react over catalyst surface at ˜600° C. Raising the reaction temperature further induced a continuous increase of conversion of both reactants.

### Catalytic Performance for Dry Reforming of Methane to Syngas

### Effect of Reaction Temperature:

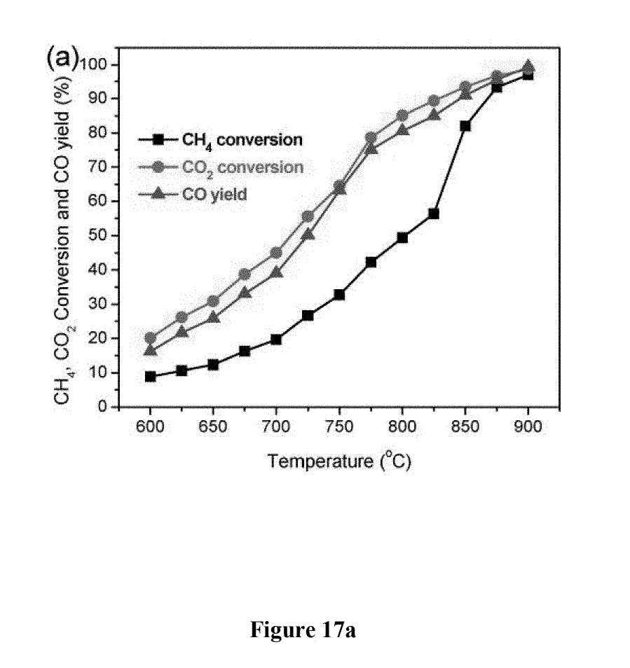

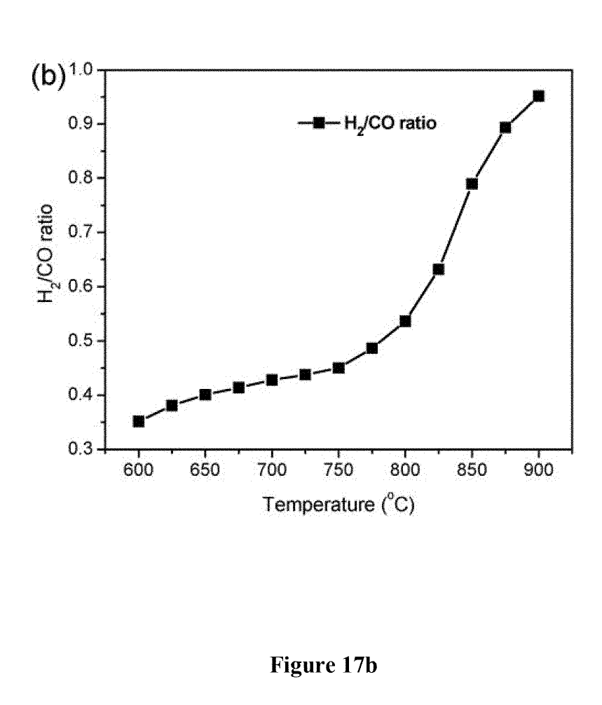

The effect of the reaction temperature on catalyst activity of tungsten carbide nanoparticles in biochar matrix and product yields in CH₄/CO₂ reforming is displayed in FIG. 17. All the data were collected at 0.5 MPa pressure. The gas samples were analyzed over 0.5 h when the reaction was unstable under low conversion conditions for temperatures between 600 and 750° C.; the rest were analyzed until a steady-state was reached (reaction time: 0.5-12 hours). The lower the reaction temperature, the lower the CH₄ and CO₂ conversions. The lower reaction temperature also lowered the CO yield, since dry reforming is an endothermic reaction. Low feed conversion (8.9% for CH₄ and 20% for CO₂) at a low temperature (600° C.) was observed. Accordingly, the dry reforming of methane reaction is shown in Eqn. (18):

CH₄+CO₂-2H₂+2CO (18)

The conversion of CO₂ should be as high as that of CH₄ and the ratio of H₂/CO should be one. However, the conversion of CO₂, as shown in FIG. 17a, was significantly higher than that of CH₄, and the H₂/CO ratio is varied from 0.35 at 600° C. to 0.95 at 900° C. (FIG. 17b). These results may be attributed to two possible side reactions: one is WC oxidized by CO₂ according to Eqn. (19):

WC+CO₂—W+2CO (19)

and the other is the reverse water gas shift reaction (RWGS) according to Eqn. (20):

H₂+CO₂—H₂O+CO (20)

These two possible side effects can lead to extra consumption of H₂ and CO₂ and extra production of CO.
Effect of Molar Feed Ratio of CH₄/CO₂

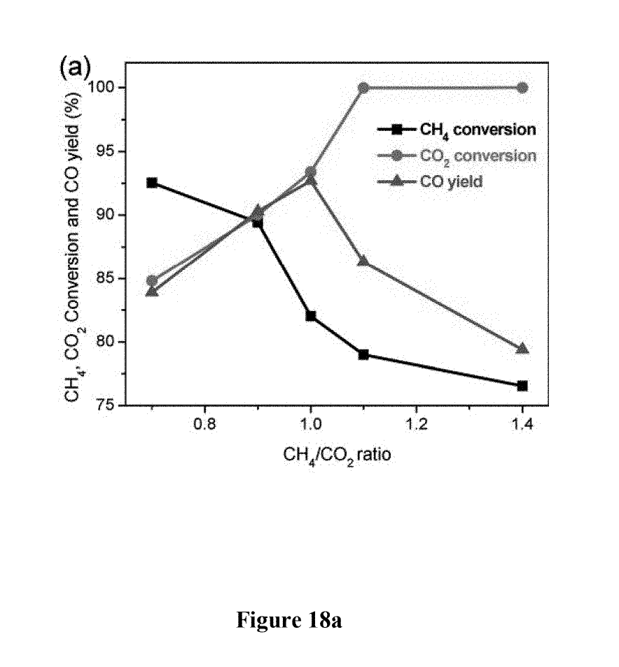

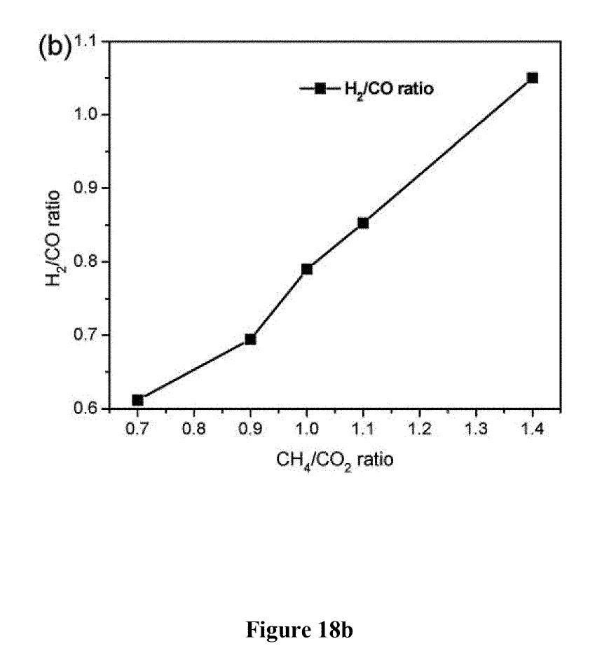

The effect of molar feed ratio of CH₄/CO₂ on the CH₄ and CO₂ conversions as well as of the H₂/CO ratio over tungsten carbide nanoparticles at 850° C. is illustrated in FIG. 18. All data were collected at 0.5 MPa pressure. The gas samples were analyzed after 5 h reaction to achieve a steady-state (reaction time: 5-24 hours). CH₄ conversion was observed to decrease with increasing of CH₄/CO₂ ratio, whereas CO₂ conversion increased with increasing CH₄/CO₂ ratio. The maximum H₂ selectivity was also be achieved with a high CH₄/CO₂ ratio. By introducing less CO₂ into the dry methane reforming process, desired H₂/CO ratios close to one are achieved, indicating that H₂ consumption undergoing RWGS was suppressed due to the lack of CO₂. Thus, it was vital to control the H₂/CO ratio for syngas production by adjusting the CH₄/CO₂ ratio.

### Effect of Gas Hourly Space Velocity (GHSV)

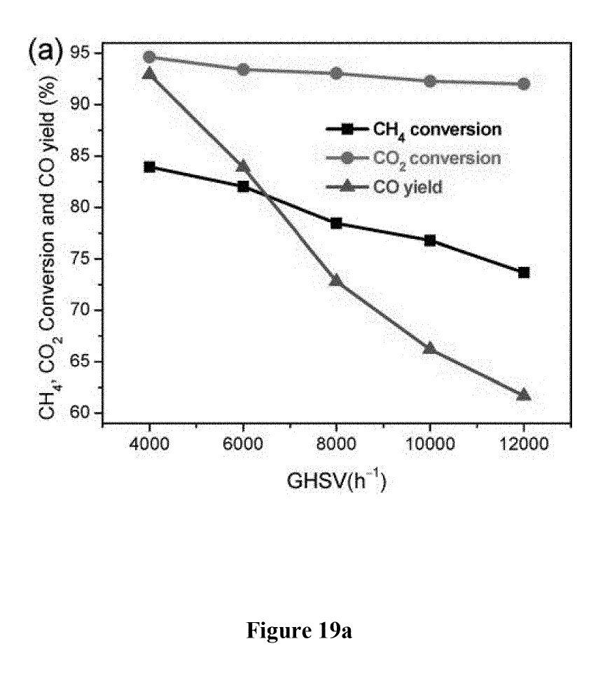

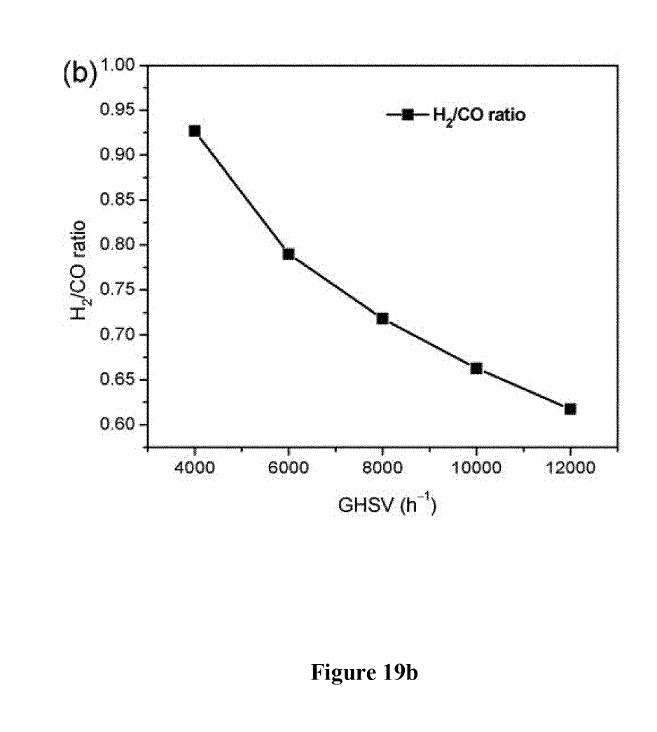

The effect of GHSV on feed conversion and on H₂/CO molar ratio in the product is shown in FIG. 19. All data were collected under 0.5 MPa pressure. The gas samples were analyzed after 5 h reaction to achieve a steady-state (reaction time: 5-24 hours). The CH₄ conversion and H₂/CO ratio decreased from 84.0% to 73.6% and 0.93 to 0.62, respectively, as the GHSV increased from 4000 to 12000 h⁻¹ over tungsten carbide nanoparticles. CO₂ conversion dropped slightly from 94.6% at 4000 h⁻¹ to 92.0% at 12000 h⁻¹. The results from varying the GHSV revealed that CO₂ dissociative adsorption was faster than that for CH₄ at lower GHSV, or a longer contact time, which allowed the slower CH₄ dissociation reaction to reach equilibrium. Thus, when the CO₂ dissociation and CH₄ splitting reactions were at equilibrium, the catalyst remained at thermodynamic equilibrium. Higher GHSV meant shorter contacting time, thus CO₂ dissociative adsorption dominated on the catalyst surface, and the reactant (CH₄) of the slow process (dissociation reaction) had less opportunity to diffuse into the active sites.

### Stability of the Catalyst

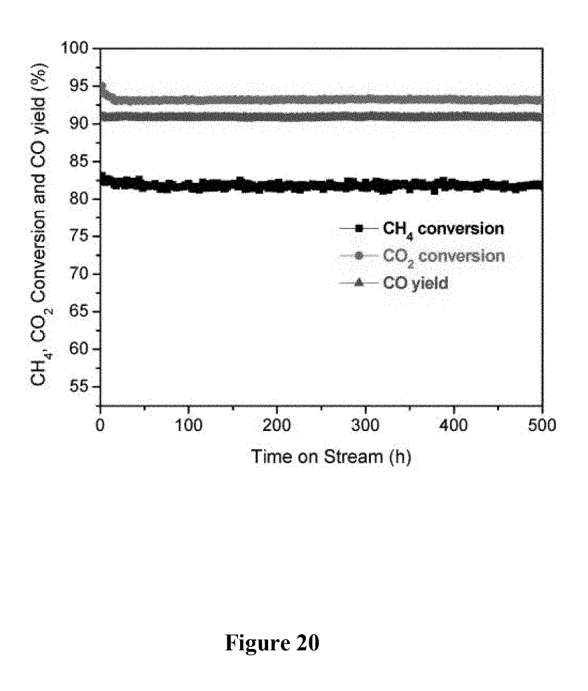

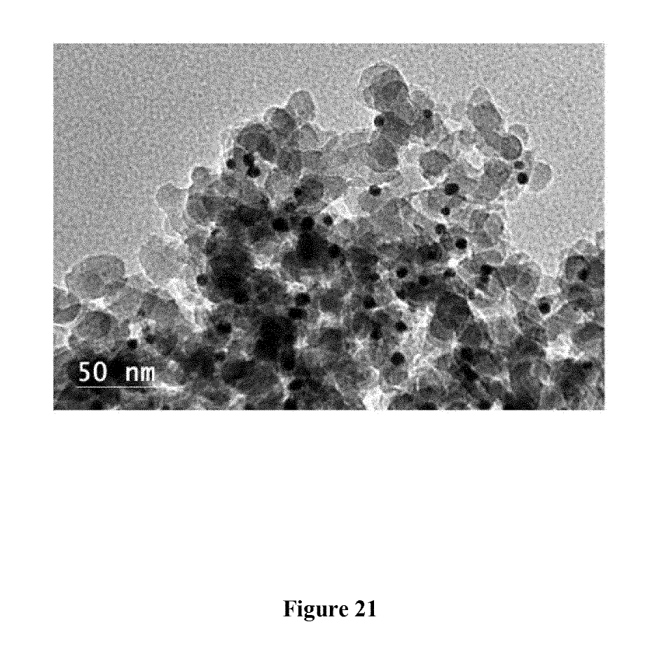

The stability of tungsten carbide nanoparticles in the biochar matrix was tested at 850° C., 0.50 MPa, GHSV of 6000 h−1 and a constant feed (CH₄/CO₂) ratio of 1 (FIG. 20). The CH₄ and CO₂ conversions increased steadily during the first 20 hours at 850° C. and then stabilized at 95% and 83%, respectively, with a CO yield of 91% and a H₂/CO ratio after 500 hours run-time remaining at around 0.87-0.91. The catalyst was found to be very stable at 850° C. for a period of over 500 hours. The pressure drop of the catalyst bed was only 0.003 MPa in the beginning; after running for 500 hours the pressure drop increased to 0.362 MPa, i.e. the inlet pressure was 0.862 MPa while the outlet pressure was 0.50 MPa. The used WC/biochar catalyst (after 500 hours testing) was characterized by elemental analysis (Table 7) and TEM (FIG. 21). Elemental analysis results (Table 7) showed that the carbon composition in the used WC/biochar catalyst (after 500 hours testing) was 77.3±2.5 wt %, and no hydrogen and nitrogen compositions were detected. The TEM image (FIG. 21) of the used catalyst sample showed that the particles were more uniform with size ranges of 5-10 nm after 500 hours testing, and no significant sintering of tungsten carbide nanoparticles and coking on the tungsten carbide nanoparticles was observed. These may be the reasons the tungsten carbide nanoparticles in the biochar matrix were still very active and stable after 500 hours testing of dry reforming of methane, as shown in FIG. 20.

### Summary

Tungsten carbide nanoparticles were successfully produced using a synthesis method by carbothermal reduction of tungsten-promoted pine biochar at 1000° C. The characterization results revealed that the tungsten carbide nanoparticle formation involved the sequence process was as follows: WO3˜WO₂˜W˜W₂C˜WC. Both the solid biochar and the volatile products (CO, H₂, and CH₄) from biochar decomposition participated in the tungsten oxide reduction and the tungsten carbide formation. The lower the reaction temperature, the lower the CH₄ and CO₂ conversions as well as the lower CO yield, since dry reforming is an endothermic reaction. CH₄ conversion was observed to decrease with increasing CH₄/CO₂ ratio, whereas CO₂ conversion increased with increasing CH₄/CO₂ ratio. The higher the GHSV, the lower the CH₄ and CO₂ conversions and the lower the CO yield. The stability testing results of the tungsten carbide nanoparticles showed no catalyst deactivation for the duration of the 500 hours of testing.

Nickel-based nano-structured catalysts were similarly successfully synthesized by thermal treatment of nickel impregnated carbon-containing materials, including raw materials like carbon black, starch, and wood char. The synthesis was achieved through cost effective thermal processes and the resultant catalyst was highly active and stable for dry reforming of methane, natural gas, and biogas to syngas.

It will be understood that various details of the presently-disclosed subject matter can be changed without departing from the scope of the subject matter disclosed herein. Furthermore, the foregoing description is for the purpose of illustration only, and not for the purpose of limitation.

Following long-standing patent law convention, the terms “a”, “an”, and “the” refer to “one or more” when used in this application, including the claims. Thus, for example, reference to “a nanocage” includes a plurality of such nanocages, and so forth.

Unless otherwise indicated, all numbers expressing quantities of ingredients, properties such as reaction conditions, and so forth used in the specification and claims are to be understood as being modified in all instances by the term “about”. Accordingly, unless indicated to the contrary, the numerical parameters set forth in this specification and claims are approximations that can vary depending upon the desired properties sought to be obtained by the invention and presently-disclosed subject matter.

As used herein, the term “about,” when referring to a value or to an amount of mass, weight, time, volume, concentration or percentage is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

The above detailed description is presented to enable any person skilled in the art to make and use the invention. Specific details have been revealed to provide a comprehensive understanding of the present invention, and are used for explanation of the information provided. These specific details, however, are not required to practice the invention, as is apparent to one skilled in the art. Descriptions of specific applications and parameters, analyses, ratios, ranges, percentages, amounts, times, temperatures, pressures, and calculations, for example, are meant to serve only as representative examples. Various modifications to the preferred embodiments may be readily apparent to one skilled in the art, and the general principles defined herein may be applicable to other embodiments and applications while still remaining within the scope of the invention. There is no intention for the present invention to be limited to the embodiments shown and the invention is to be accorded the widest possible scope consistent with the principles and features disclosed herein.

While various embodiments of the present invention have been described above, it should be understood that they have been presented by way of example and not limitation. It will be apparent to persons skilled in the relevant art(s) that various changes in form and detail can be made therein without departing from the spirit and scope of the present invention. In fact, after reading the above description, it will be apparent to one skilled in the relevant art(s) how to implement the invention in alternative embodiments. Thus, the present invention should not be limited by any of the above-described exemplary embodiments.

The processes, systems, methods, structures, and compositions of the present invention are often best practiced by empirically determining the appropriate values of the operating parameters, or by conducting simulations to arrive at best design for a given application.

Accordingly, all suitable modifications, combinations, and equivalents should be considered as falling within the spirit and scope of the invention.

### REFERENCES

1. S. Rasi, A. Veijanen and J. Rintala, Energy, 2007, 32, 1375-1380.
2. C. S. Lau, A. Tsolakis and M. L. Wyszynski, Int. J. Hydrogen Energy, 2011, 36, 397-404.
3. A. Yasar, A. Ali, A. B. Tabinda and A. Tahir, Renewable Sustainable Energy Rev., 2015, 43, 126-132.
4. S. Nathan, J. M. Mallikarjuna and A. Ramesh, Energy Convers. Manage., 2010, 51, 1347-1353.
5. M. Komiyama, T. Misonou, S. Takeuchi, K. Umetsu and J. Takahashi, Int. Congr. Ser., 2006, 1293, 234-237.
6. S. Vasileiadis and Z. Ziaka-Vasileiadou, Chem. Eng. Sci., 2004, 59, 4853-4859.
7. K. Tao, S. Zhou, Q. Zhang, C. Kong, Q. Ma, N. Tsubaki and L. Chen, RSC Adv., 2013, 3, 22285-22294.
8. Y. Lu, B. Cao, F. Yu, J. Liu, Z. Bao and J. Gao, Chem Cat Chem, 2014, 6, 473-478.
9. Z. Bao, Y. Lu, J. Han, Y. Li and F. Yu, Appl. Catal., A, 2015, 491, 116-126.
10. Y. H. Hu and E. Ruckenstein, Adv. Catal., 2004, 48, 297-345.
11. L. Xu, Z. Miao, H. Song, W. Chen and L. Chou, Catal. Sci. Technol., 2014, 4, 1759-1770.
12. N. Wang, K. Shen, X. Yu, W. Qian and W. Chu, Catal. Sci. Technol., 2013, 3, 2278-2287.
13. L. Mo, K. K. K. M. Leong and S. Kawi, Catal. Sci. Technol., 2014, 4, 2107-2114.
14. R. B. Levy and M. Boudart, Science, 1973, 181, 547-549.
15. X.-H. Wang, M.-H. Zhang, W. Li and K.-Y. Tao, Catal. Today, 2008, 131, 111-117.
16. J. B. Claridge, A. P. E. York, A. J. Brungs, C. Marquez-Alvarez, J. Sloan, S. C. Tsang and M. L. H. Green, J. Catal., 1998, 180, 85-100.
17. L. E. McCandlish, B. H. Kear and B. K. Kim, Mater. Sci. Technol., 1990, 6, 953-957.
18. M. A. Xueming, J. I. Gang, Z. Ling and D. Yuanda, J. Alloys Compd., 1998, 264, 267-270.
19. J. C. Kim and B. K. Kim, Scr. Mater., 2004, 50, 969-972.
20. W. Chang, G. Skandan, S. C. Danforth and B. H. Kear, Nanostruct. Mater., 1994, 4, 507-520.
21. C. Liang, F. Tian, Z. Wei, Q. Xin and C. Li, Nanotechnology, 2003, 14, 955-958.
22. C. Liang, W. Ma, Z. Feng and C. Li, Carbon, 2003, 41, 1833-1839.
23. C. Liang, P. Ying and C. Li, Chem. Mater., 2002, 14, 3148-3151.
24. H. Lang, S. Blau, G. Rheinwald and G. Wildermuth, J. Organomet. Chem., 1995, 489, C17-C21.
25. S. Chouzier, P. Afanasiev, M. Vrinat, T. Cseri and M. Roy-Auberger, J. Solid State Chem., 2006, 179, 3314-3323.
26. S. V. Pol, V. G. Pol and A. Gedanken, Adv. Mater., 2006, 18, 2023-2027.
27. J. A. Nelson and M. J. Wagner, Chem. Mater., 2002, 14, 1639-1642.
28. C. Li, X. Yang, B. Yang and Y. Qian, J. Am. Ceram. Soc., 2006, 89, 320-322.
29. L. Volpe and M. Bourdart, J. Solid State Chem., 1985, 59, 348-356.
30. J. S. Lee, S. T. Oyama and M. Bourdart, J. Catal., 1987, 106, 125-133.
31. D. Mordenti, D. Brodzki and G. Djéga-Mariadassou, J. Solid State Chem., 1998, 141, 114-120.
32. C. Liang, F. Tian, Z. Li, Z. Feng, Z. Wei and C. Li, Chem. Mater., 2003, 15, 4846-4853.
33. M. M. Mdleleni, T. Hyeon and K. S. Suslick, J. Am. Chem. Soc., 1998, 120, 6189.
34. G. Dantsin and K. S. Suslick, J. Am. Chem. Soc., 2000, 122, 5214-5215.
35. A. Torabi and T. H. Etsell, J. Power Sources, 2012, 212, 47-56.
36. H. Romanus, V. Cimalla, J. A. Schaefer, L. Spiep, G. Ecke and J. Pezoldt, Thin Solid Films, 2000, 359, 146-149.
37. R. L. Miller, P. T. Wolczanski and A. L. Rheingold, J. Am. Chem. Soc., 1993, 115, 10422-10423.
38. G. Li, C. Ma, Y. Zheng and W. Zhang, Microporous Mesoporous Mater., 2005, 85, 234-240.
39. J. Lemaitre, B. Vidick and B. Delmon, J. Catal., 1986, 99, 415-427.
40. L. S. Abovyan, H. H. Nersisyan and S. L. Kharatyan, Chemical Physics Reports, 1995, 13, 1740-1747.
41. H. Meng and P. K. Shen, J. Phys. Chem. B, 2005, 109, 22705-22709.
42. K. K. Lai and H. H. Lamb, Chem. Mater., 1995, 7, 2284-2292.
43. S. Wanner, L. Hilaire, P. Wehrer, J. P. Hindermann and G. Maire, Appl. Catal., A, 2000, 203, 55-70.
44. Q. Yan, C. Wan, J. Liu, J. Gao, F. Yu, J. Zhang and Z. Cai, Green Chem., 2013, 15, 1631-1640.
45. S. Ren, H. Lei, L. Wang, Q. Bu, S. Chen and J. Wu, RSC Adv., 2014, 4, 10731-10737.
46. Y. Lu, F. Yu, J. Hu and J. Liu, Appl. Catal., A, 2012, 429-430, 48-58.
47. L. Hu, S. Ji, Z. Jiang, H. Song, P. Wu and Q. Liu, J. Phys. Chem. C, 2007, 111, 15173-15184.
48. Y. Sun, H. Cui, S. X. Jin and C. X. Wang, J. Mater. Chem., 2012, 22, 16566-16571.
49. Z. Wu, Y. Yang, D. Gu, Q. Li, D. Feng, Z. Chen, B. Tu, P. A. Webley and D. Zhao, Small, 2009, 5, 2738-2749.
50. T. Xiao, H. Wang, A. P. E. York, V. C. Williams and M. L. H. Green, J. Catal., 2002, 209, 318-330.
51. D. Pakhare and J. Spivey, Chem. Soc. Rev., 2014, 43, 7813-7837.
52. C. Wang, N. Sun, M. Kang, X. Wen, N. Zhao, F. Xiao, W. Wei, T. Zhao and Y. Sun, Catal. Sci. Technol., 2013, 3, 2435-2443.
53. T. Xiao, A. Hanif, A. P. E. York, J. Sloan and M. L. H. Green, Phys. Chem. Chem. Phys., 2002, 4, 3522-3529.
54. X. Du, L. J. France, V. L. Kuznetsov, T. Xiao, P. P. Edwards, H. AIMegren and A. Bagabas, Appl. Petrochem. Res., 2014, 4, 137-144.
55. D. Baudouin, U. Rodemerck, F. Krumeich, A. de Mallmann, K. C. Szeto, H. Menard, L. Veyre, J.-P. Candy, P. B. Webb, C. Tieuleux and C. Copéret, J. Catal., 2013, 297, 27-34.
56. R. Benrabaa, A. Löfberg, A. Rubbens, E. Bordes-Richard, R. N. Vannier and A. Barama, Catal. Today, 2013, 203, 188-195.
57. S. Pavlova, L. Kapokova, R. Bunina, G. Alikina, N. Sazonova, T. Krieger, A. Ishchenko, V. Rogov, R. Gulyaev, V. Sadykov and C. Mirodatos, Catal. Sci. Technol., 2012, 2, 2099-2108.

What is claimed is:

1. A method for synthesizing a nanostructured catalyst, comprising:
forming an aqueous solution including a metal salt;
subsequently adding a carbon source to the aqueous solution;
drying the aqueous solution to obtain a sample;
thermally treating the sample in a carrier gas to obtain a nanostructured catalyst including a metal nanoparticle; and
washing the nanostructured catalyst including the metal nanoparticle to remove the metal nanoparticle and obtain the nanostructured catalyst.

2. The method of claim 1, wherein the metal salt is selected from a nickel nitrate, a nickel sulfide, a nickel sulfate, a nickel carbonate, a nickel hydroxide, a nickel carboxylate, or a nickel halide, or a combination thereof.

3. The method of claim 2, wherein the metal salt is selected from nickel nitrate and nickel chloride.

4. The method of claim 1, wherein the metal salt is ammonium tungstate or ammonium molybdate.

5. The method of claim 1, wherein the aqueous solution comprises an equal weight ratio of the metal salt and the carbon source.

6. The method of claim 1, wherein the step of drying the aqueous solution comprises drying the aqueous solution at a temperature of about 80° C. to about 110° C.

7. The method of claim 1, wherein the carbon source is an organic carbon source and is lignin, wood char, starch, sugars, biomass-derived carbon materials, or a combination thereof.

8. The method of claim 1, wherein the step of thermally treating the sample comprises heating the sample in a tubular electric resistance furnace.

9. The method of claim 1, wherein the carrier gas is oxygen-free.

10. The method of claim 8, wherein the carrier gas is selected from Ar₂, H₂, N₂, or a combination thereof.

11. The method of claim 1, wherein the step of thermally treating the sample is performed at a temperature of about 900° C. to about 1100° C.

12. The method of claim 1, wherein the step of thermally treating the sample comprises heating the sample for a time period of about 1 hour to about 3 hours.

13. The method of claim 2, wherein the step of thermally treating the sample comprises heating the sample at a temperature of about 900° C. for about 1 hour.

14. The method of claim 4, wherein the step of thermally treating the sample comprises heating the sample at a temperature of about 1000° C. for about 3 hours.

15. The method of claim 2, wherein the nanostructured catalyst has an average diameter of about 30 nm.

16. The method of claim 4, wherein the nanostructured catalyst has a Brunauer-Emmett-Teller (BET) surface area of about 125 to about 145 m² g⁻¹.

17. A nickel nanostructured catalyst according to the method of claim 2.

18. A tungsten nanostructured catalyst or a molybdenum nanostructured catalyst according to the method of claim 4.

19. A method of dry reforming a methane-containing gas, the method comprising:
synthesizing a nanostructured catalyst by
first forming an aqueous solution including a metal salt;
subsequently adding a carbon source to the aqueous solution;
drying the aqueous solution to obtain a sample;
thermally treating the sample in a carrier gas to obtain a nanostructured catalyst including a metal nanoparticle; and
washing the nanostructured catalyst including the metal nanoparticle to remove the metal nanoparticle and obtain the nanostructured catalyst; and
exposing the methane-containing gas to the nanostructured catalyst.

20. The method of claim 19, wherein the exposing the methane-containing gas is performed at a temperature of about 600° C. to about 800° C.

21. The method of claim 19, wherein the exposing the methane-containing gas is performed at a GHSV of between about 4000 h⁻¹ to about 8000 h⁻¹.

22. The method of claim 19, wherein the methane-containing gas is methane, natural gas, or biogas.
